(19) United States
(12) Patent Application Publication
(10) Pub. No.: US 2026/0064248 A1
(43) Pub. Date: Mar. 5, 2026

(54) ELECTRONIC APPARATUS AND CONTROLLING METHOD THEREOF

(71) Applicant: SAMSUNG ELECTRONICS CO., LTD., Suwon-si (KR)

(72) Inventors: Sanghyun JANG, Suwon-si (KR); Changsoo NOH, Suwon-si (KR); Byungyong LEE, Suwon-si (KR); Sanghee LEE, Suwon-si (KR); Eugene LEE, Suwon-si (KR)

(73) Assignee: SAMSUNG ELECTRONICS CO., LTD., Suwon-si (KR)

(21) Appl. No.: 19/246,101

(22) Filed: Jun. 23, 2025

Related U.S. Application Data
(63) Continuation of application No. PCT/KR2025/006650, filed on May 16, 2025.

(30) Foreign Application Priority Data
Aug. 30, 2024 (KR) 10-2024-0117423

(51) Int. Cl. G06F 3/0484; G06F 3/0481

(52) U.S. Cl. CPC G06F 3/0484; G06F 3/0481

(57) ABSTRACT

An electronic apparatus includes memory storing instructions, a display, and at least one processor including processing circuitry, wherein the instructions, when executed by the at least one processor individually or collectively, display a first screen comprising a plurality of thumbnail images for each of a plurality of contents, and based on receiving a user input selecting a first thumbnail image of a first content among the plurality of thumbnail images, obtain content information of the first content, generate a guide UI based on the content information, and based on the user input being received for at least a threshold time, display a second screen comprising the guide UI.

### CROSS-REFERENCE TO RELATED APPLICATION

This application is a bypass continuation of International Application No. PCT/KR2025/006650, filed on May 16, 2025, which is based on and claims priority to Korean Patent Application No. 10-2024-0117423, filed on Aug. 30, 2024, in the Korean Intellectual Property Office, the disclosures of which are incorporated by reference herein in their entireties.

### BACKGROUND

### 1. Field

The disclosure relates to an electronic apparatus and a controlling method thereof. More particularly, this disclosure relates to an electronic apparatus that generates a guide UI providing information related to a content, and a controlling method thereof.

### 2. Related Art

In case a screen for selecting a plurality of contents is displayed, a plurality of thumbnail images may be displayed. A thumbnail image may indicate one image or one text indicating a content. As a thumbnail image is provided by a drafter of a content, it may be different from the actual content included in the content.

A thumbnail image may include a provocative or an exaggerated expression to draw users' interest. In case a user selects a content through a thumbnail image, the user may feel uncomfortable as an item different from the actual content is selected.

Also, it would be difficult for a user to figure out what the details of a content are just with a thumbnail image. In addition, in case a text is not displayed on a thumbnail image, it would be difficult for a user to figure out what the details of a content are just with the image.

### SUMMARY

The disclosure was devised for improving the aforementioned problem, and the purpose of the disclosure is in providing an electronic apparatus that generates a guide UI related to a content for providing information different from a displayed thumbnail image, and a controlling method thereof.

According to an embodiment, an electronic apparatus includes memory storing instructions, a display, and at least one processor including processing circuitry, The instructions, when executed by the at least one processor individually or collectively, cause the electronic apparatus to display, on the display, a first screen comprising a plurality of thumbnail images for each of a plurality of contents, based on receiving a user input selecting a first thumbnail image of a first content among the plurality of thumbnail images, obtain content information of the first content, generate a guide user interface (UI) based on the content information, and based on the user input being received for at least a threshold time, display a second screen comprising the guide UI.

The instructions, when executed by the at least one processor individually or collectively, further may cause the electronic apparatus to based on receiving the user input, display an activation UI at a location corresponding to the first thumbnail image, and based on the location of the activation UI being consistent for at least the threshold time, display the second screen comprising the guide UI.

The instructions, when executed by the at least one processor individually or collectively, further may cause the electronic apparatus to based on a touch input for selecting the first thumbnail image being maintained for at least the threshold time, display the second screen comprising the guide UI.

The content information may include at least one of image data, audio data, thumbnail data, or metadata of the first content, and the thumbnail data may include the first thumbnail image, and the metadata may include at least one of a title, a drafter, a provider, cast, story summary, a resolution, a codec, or an age restriction for viewing.

The instructions, when executed by the at least one processor individually or collectively, further may cause the electronic apparatus to identify a thumbnail text based on the first thumbnail image, obtain a representative text of the first content based on the content information, and based on identifying a predetermined event related to the thumbnail text, generate the guide UI.

The instructions, when executed by the at least one processor individually or collectively, further may cause the electronic apparatus to generate the guide UI based on a similarity between the thumbnail text and the representative text.

The instructions, when executed by the at least one processor individually or collectively, further may cause the electronic apparatus to based on the thumbnail text including a predetermined text, generate the guide UI, the predetermined text may include at least one of an interrogative expression, an exaggerated expression, or an advertising expression.

The instructions, when executed by the at least one processor individually or collectively, further may cause the electronic apparatus to obtain user information including at least one of an account, a name, an age, a sex, a language, a country, health, or a preferred category, and generate the guide UI based on the content information and the user information.

The instructions, when executed by the at least one processor individually or collectively, further may cause the electronic apparatus to obtain environment information including at least one of a location, a date, or weather, and generate the guide UI based on the content information and the environment information.

The instructions, when executed by the at least one processor individually or collectively, further may cause the electronic apparatus to obtain screen information including at least one of a resolution of the display or a resolution of an area where the first thumbnail image is displayed, and generate the guide UI based on the content information and the screen information.

According to an embodiment, a controlling method of an electronic apparatus, the controlling method being performed by one or more processors, and the controlling method comprising displaying a first screen comprising a plurality of thumbnail images for each of a plurality of contents, based on receiving a user input selecting a first thumbnail image of a first content among the plurality of thumbnail images, obtaining content information of the first content, generating a guide user interface (UI) based on the content information, and based on the user input being received for at least a threshold time, displaying a second screen comprising the guide UI.

The controlling method further may include based on receiving the user input, displaying an activation UI at a location corresponding to the first thumbnail image, and the displaying the second screen may include based on the location of the activation UI being consistent for at least the threshold time, displaying the second screen comprising the guide UI.

The displaying the second screen may include based on a touch input for selecting the first thumbnail image being maintained for at least the threshold time, displaying the second screen comprising the guide UI.

The content information may include at least one of image data, audio data, thumbnail data, or metadata of the first content, and the thumbnail data may include the first thumbnail image, and the metadata may include at least one of a title, a drafter, a provider, cast, story summary, a resolution, a codec, or an age restriction for viewing.

The controlling method further may include identifying a thumbnail text based on the first thumbnail image, and obtaining a representative text of the first content based on the content information, and the generating the guide UI may include based on identifying a predetermined event related to the thumbnail text, generating the guide UI.

According to an embodiment, non-transitory computer-readable medium storing instructions, the instructions comprising one or more instructions that, when executed by one or more processors individually or collectively, cause the one or more processors to display a first screen comprising a plurality of thumbnail images for each of a plurality of contents, and based on receiving a user input selecting a first thumbnail image of a first content among the plurality of thumbnail images, obtain content information of the first content, generate a guide UI based on the content information, and based on the user input being received for at least a threshold time, display a second screen comprising the guide UI.

### BRIEF DESCRIPTION OF DRAWINGS

FIG. 1 is a diagram illustrating an operation of displaying a guide UI according to an embodiment;

FIG. 2 is a block diagram that illustrates an electronic apparatus according to an embodiment;

FIG. 3 is a block diagram illustrating a detailed configuration of the electronic apparatus in FIG. 2 according to an embodiment;

FIG. 4 is a diagram illustrating a guide UI generation model according to an embodiment;

FIG. 5 is a flowchart illustrating the generation of a guide UI according to an embodiment;

FIG. 6 is a flowchart illustrating the generation of a guide UI if a predetermined user input is identified according to an embodiment;

FIG. 7 is a flowchart illustrating obtaining at least one of content information, user information, or environment information if a predetermined user input is identified according to an embodiment;

FIG. 8 is a flowchart illustrating obtaining at least one of content information, user information, or environment information before a user input selecting a first content is received according to an embodiment;

FIG. 9 is a flowchart illustrating the generation of a guide UI according to a predetermined event according to an embodiment;

FIG. 10 is a flowchart illustrating the comparing of a representative text and a thumbnail text according to an embodiment;

FIG. 11 is a flowchart illustrating determining whether a thumbnail text includes a predetermined text according to an embodiment;

FIG. 12 is a diagram illustrating selection of a first content according to an embodiment;

FIG. 13 is a diagram illustrating generating a guide UI according to an embodiment;

FIG. 14 is a diagram illustrating generating a guide UI when a thumbnail text includes an interrogative expression according to an embodiment;

FIG. 15 is a diagram illustrating generating a guide UI when a thumbnail text includes an exaggerated expression according to an embodiment;

FIG. 16 is a diagram illustrating generating a guide UI when a thumbnail text has no relevance to an image according to an embodiment;

FIG. 17 is a diagram illustrating generating a guide UI for a real time content according to an embodiment;

FIG. 18 is a diagram illustrating generating a guide UI for a sport content according to an embodiment;

FIG. 19 is a diagram illustrating generating a plurality of guide UIs for one content according to an embodiment;

FIG. 20 is a diagram illustrating generating a guide UI according to a resolution according to an embodiment;

FIG. 21 is a diagram illustrating generating a guide UI according to an age according to an embodiment;

FIG. 22 is a diagram illustrating generating a guide UI according to a language according to an embodiment;

FIG. 23 is a diagram illustrating generating a guide UI based on an arrangement location of an electronic apparatus according to an embodiment;

FIG. 24 is a diagram illustrating overlapping a guide UI with a thumbnail text and displaying it according to an embodiment;

FIG. 25 is a diagram illustrating generating a screen including a guide UI according to an embodiment;

FIG. 26 is a diagram illustrating applying transparency of a guide UI according to an embodiment;

FIG. 27 is a diagram illustrating displaying a guide UI to fit the size of an area wherein a content is displayed according to an embodiment;

FIG. 28 is a diagram illustrating displaying a guide UI in an area different from an area wherein a content is displayed according to an embodiment;

FIG. 29 is a flowchart illustrating generating a guide UI in consideration of a category of a content according to an embodiment; and

FIG. 30 is a flowchart illustrating a controlling method of an electronic apparatus according to an embodiment.

### DETAILED DESCRIPTION

Hereinafter, the disclosure will be described in detail with reference to the accompanying drawings.

As terms used in the embodiments of the disclosure, general terms that are currently used widely were selected as far as possible, in consideration of the functions described in the disclosure. However, the terms may vary depending on the intention of those skilled in the art who work in the pertinent field or previous court decisions, or emergence of new technologies, etc. Also, in particular cases, there may be terms that were designated by the applicant on his own, and in such cases, the meaning of the terms will be described in detail in the relevant descriptions in the disclosure. Accordingly, the terms used in the disclosure should be defined based on the meaning of the terms and the overall content of the disclosure, but not just based on the names of the terms.

Also, in this specification, expressions such as “have,” “may have,” “include,” and “may include” denote the existence of such characteristics (e.g.: elements such as numbers, functions, operations, and components), and do not exclude the existence of additional characteristics.

In addition, the expression “at least one of A and/or B” should be interpreted to mean any one of “A” or “B” or “A and B.”

Further, the expressions “first,” “second” and the like used in this specification may be used to describe various elements regardless of any order and/or degree of importance. Also, such expressions are used only to distinguish one element from another element, and are not intended to limit the elements.

Meanwhile, the description in the disclosure that one element (e.g.: a first element) is “(operatively or communicatively) coupled with/to” or “connected to” another element (e.g.: a second element) should be interpreted to include both the case where the one element is directly coupled to the another element, and the case where the one element is coupled to the another element through still another element (e.g.: a third element).

Also, singular expressions include plural expressions, unless defined obviously differently in the context. In addition, in the disclosure, terms such as “include” or “consist of” should be construed as designating that there are such characteristics, numbers, steps, operations, elements, components, or a combination thereof described in the specification, but not as excluding in advance the existence or possibility of adding one or more of other characteristics, numbers, steps, operations, elements, components, or a combination thereof.

Further, in the disclosure, “a module” or “a part” performs at least one function or operation, and may be implemented as hardware or software, or as a combination of hardware and software. In addition, a plurality of “modules” or “parts” may be integrated into at least one module and implemented as at least one processor, except “a module” or “a part” that needs to be implemented as specific hardware.

Also, in this specification, the term “user” may refer to a person who uses an electronic apparatus or an apparatus using an electronic apparatus (e.g.: an artificial intelligence electronic apparatus).

Hereinafter, an embodiment of the disclosure will be described in more detail with reference to the accompanying drawings.

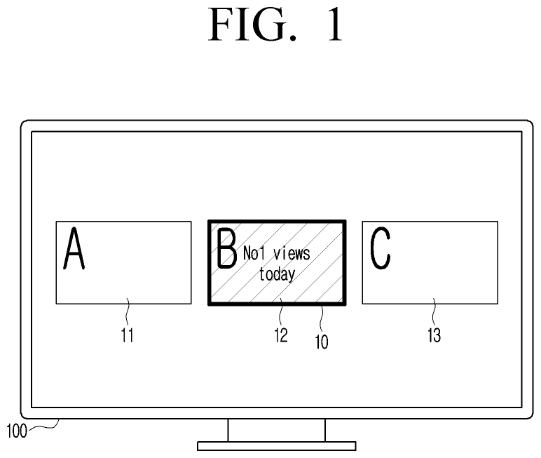

FIG. 1 is a diagram for illustrating an operation of displaying a guide UI according to an embodiment.

Referring to FIG. 1, an electronic apparatus 100 may display a plurality of contents A, B, C. The electronic apparatus 100 may display thumbnails for displaying the plurality of contents A, B, C.

The electronic apparatus 100 may display a first thumbnail corresponding to the A content in a first area 11. The electronic apparatus 100 may display a second thumbnail corresponding to the B content in a second area 12. The electronic apparatus 100 may display a third thumbnail corresponding to the C content in a third area 13.

The electronic apparatus 100 may display an activation UI 10 indicating a content (or a thumbnail) selected by a user. The activation UI 10 may be a UI indicating the currently selected content. The activation UI 10 may include a highlight UI for indicating the content currently selected by the user. The activation UI 10 may include a UI guiding the location of the selected content (or thumbnail). The location wherein the activation UI 10 is displayed may be changed according to a user's input.

The electronic apparatus 100 may display the activation UI 10 based on an area wherein a content (or a thumbnail) selected by the user is displayed among areas wherein thumbnails of a plurality of contents are displayed.

As an example, if a user input selecting the B content is received, the electronic apparatus 100 may display the activation UI 10 in the area 12 wherein the second thumbnail of the B content is displayed.

If a predetermined user input is identified, the electronic apparatus 100 may display a guide UI related to the B content.

The guide UI may be a UI providing information on a selected content. The guide UI may include at least one of information explaining a selected content or information summarizing the content.

As an example, the guide UI may include a text which is “No. 1 views today.” The electronic apparatus 100 may analyze information on the B content, and display the guide UI indicating that the B content has the highest views today. The electronic apparatus 100 may display the guide UI in the second area 12 wherein the B content is displayed.

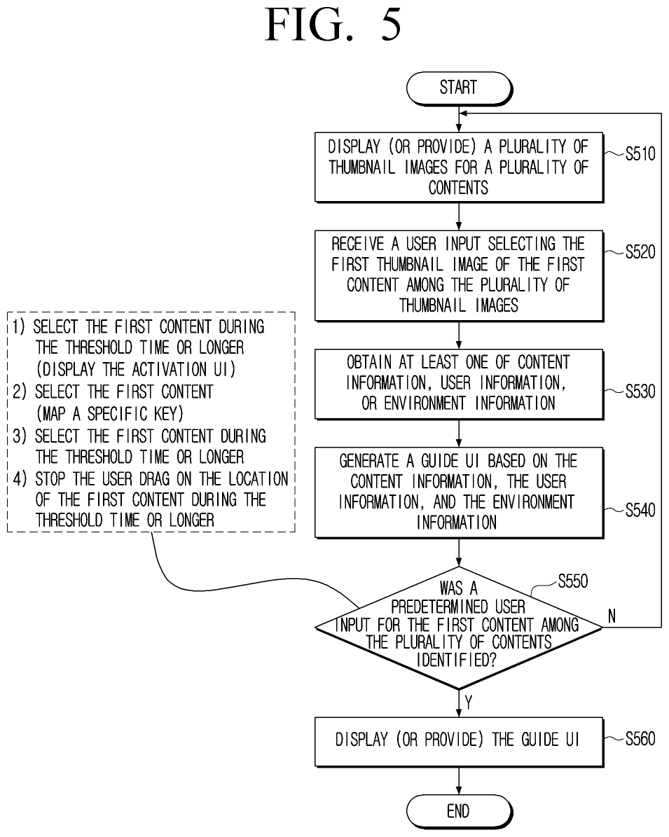

The predetermined user input may indicate a user input that selects one content during a threshold time or longer. A content related to the predetermined user input will be described in FIG. 5.

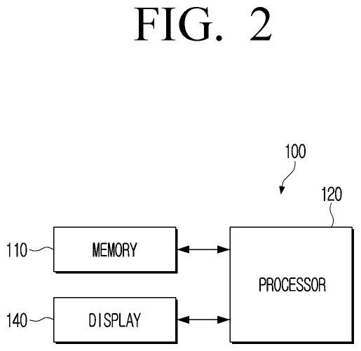

FIG. 2 is a block diagram that illustrates the electronic apparatus 100 according to an embodiment.

The electronic apparatus 100 may include at least one of memory 110 storing instructions, a display 140, or at least one processor 120 including processing circuitry.

The at least one processor 120 may control the display 140 to display a first screen including a plurality of thumbnail images for each of a plurality of contents, and if a user input selecting a first thumbnail image of a first content among the plurality of thumbnail images is received, obtain content information of the first content, and generate a guide UI based on the content information, and if the first thumbnail image is selected during the threshold time or longer, control the display 140 to display a second screen including the guide UI.

The at least one processor 120 may display a first screen for providing a plurality of contents. The at least one processor 120 may display the first screen including thumbnail images representing each of the plurality of contents.

The thumbnail images may be described as at least one of a preview image, a reduced image, or a summary image.

As an example, the first screen may be a screen for providing the first content, the second content, and the third content. The first screen may include the first thumbnail image for selecting the first content, the second thumbnail image for selecting the second content, and the third thumbnail image for selecting the third content.

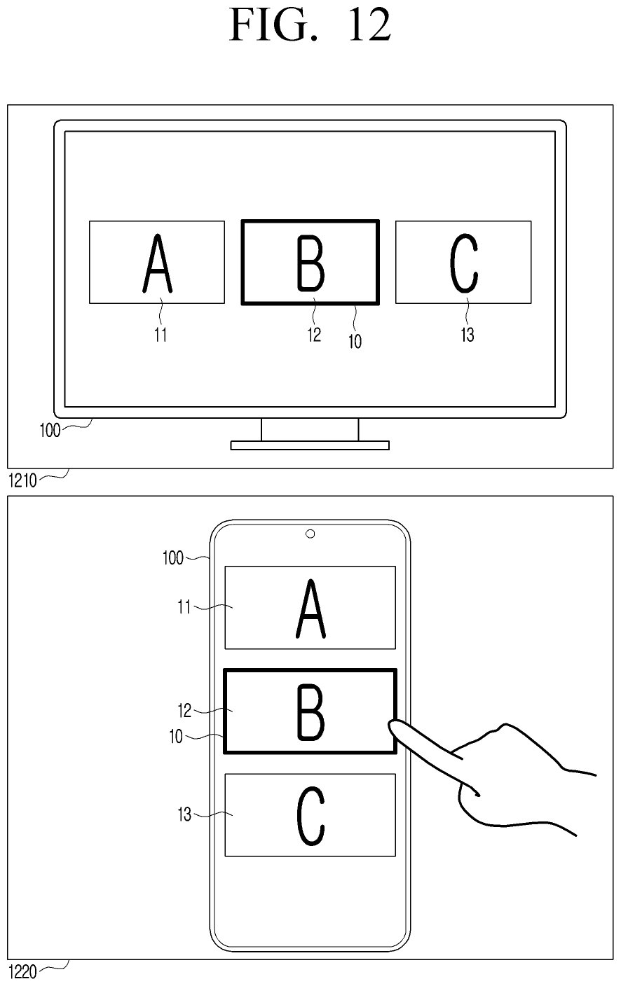

The user may select a specific content or a specific thumbnail image through the first screen. The first screen will be described in FIG. 1 and FIG. 12.

The at least one processor 120 may receive a user input selecting the first thumbnail image indicating the first content among the plurality of thumbnail images.

As an example, the user input may be received through a remote control apparatus that is communicatively connected with the electronic apparatus 100.

When the user input selecting the first thumbnail image is received, the at least one processor 120 may control the display 140 to display the activation UI in the location corresponding to the first thumbnail image. If the location of the activation UI is not changed during the threshold time, the at least one processor 120 may control the display 140 to display the second screen including the guide UI. An embodiment related to this will be described in the embodiment 1210 in FIG. 12.

As an example, the electronic apparatus 100 may directly receive a user input. The user may input a user input into the electronic apparatus 100 through a touch sensor part (or a touch panel).

If a touch input for selecting the first thumbnail image is maintained or is consistent during the threshold time or longer (e.g., at least the threshold time), the at least one processor 120 may control the display 140 to display the second screen including the guide UI.

The content information may include at least one of image data, audio data, thumbnail data, or metadata of the first content. The thumbnail data may include the first thumbnail image. The metadata may include at least one of a title, a drafter, a provider, cast, story summary, a resolution, a codec, or an age restriction for viewing.

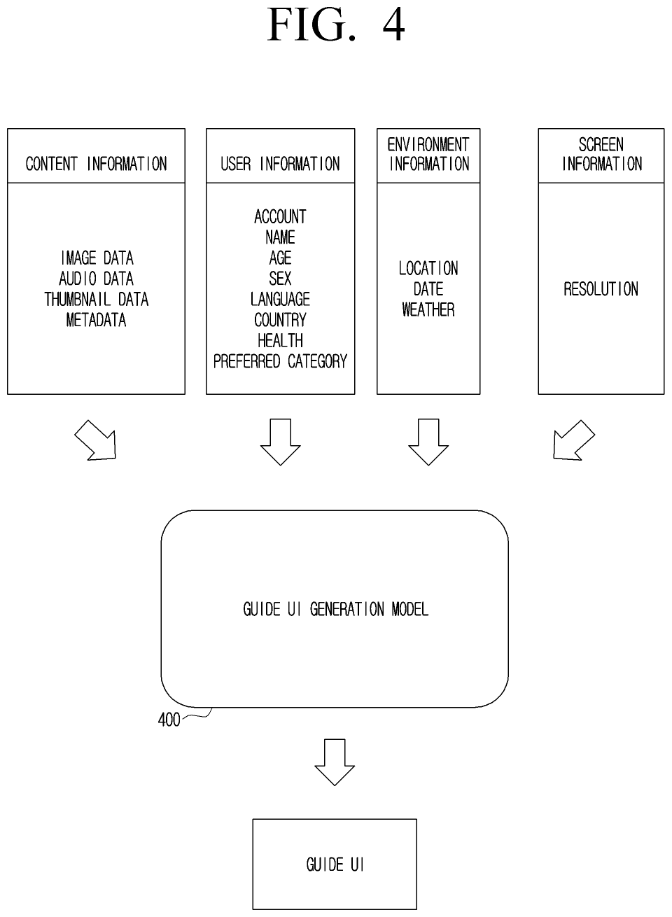

The at least one processor 120 may generate a guide UI based on at least one of the image data, the audio data, the thumbnail data, or the metadata included in the content information. The image data may also be described as video data. A content may include image data and audio data. A content related to the content information will be described in FIG. 4.

The at least one processor 120 may identify a thumbnail text based on the first thumbnail image. The at least one processor 120 may obtain a representative text of the first content based on the content information. If a predetermined event related to the thumbnail text is identified, the at least one processor 120 may generate a guide UI.

The at least one processor 120 may identify (or obtain) the first thumbnail image displayed on the first screen. The at least one processor 120 may obtain (or extract) a thumbnail text based on the first thumbnail image. The first thumbnail image may include the thumbnail text. The thumbnail text may be information generated by the manufacturer of the first content. The first thumbnail image may not coincide with the actual content of the first content.

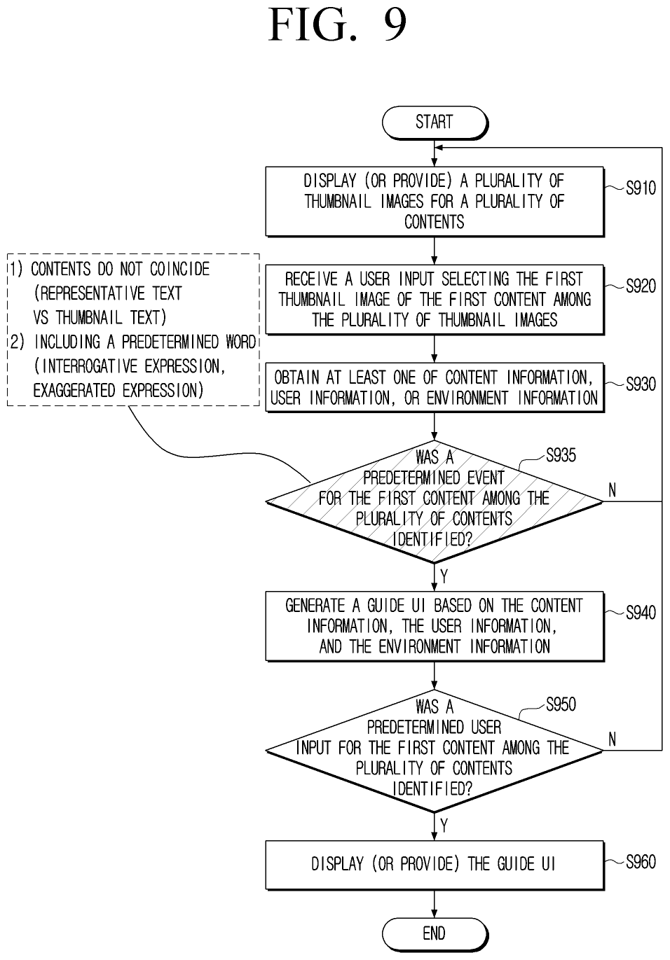

The at least one processor 120 may obtain (or identify) a representative text based on the content information. The at least one processor 120 may identify a representative text based on at least one of the image data, the audio data, or the metadata included in the content information. Explanation related to this will be described in FIG. 9.

The at least one processor 120 may receive image data and/or audio data corresponding to the first content. The at least one processor 120 may obtain a representative text based on the image data and/or the audio data received during a predetermined time. It may take a lot of time for the at least one processor 120 to analyze the entire image data and the entire audio data of the first content. Accordingly, the at least one processor 120 may obtain a representative text based on the image data and/or the audio data received during the predetermined time. The predetermined time may be changed according to the user's setting.

The at least one processor 120 may receive metadata corresponding to the first content. The at least one processor 120 may obtain a representative text based on story summary (or summary information) included in the metadata.

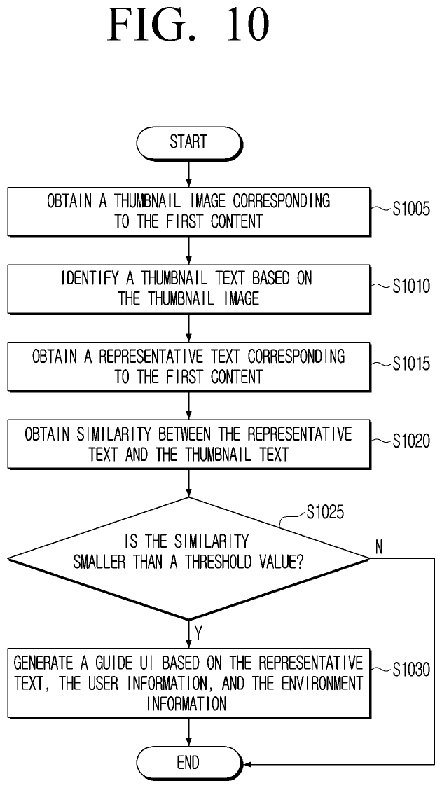

The at least one processor 120 may obtain similarity between the thumbnail text and the representative text, and if the similarity is smaller than a threshold value, generate a guide UI. Explanation related to this will be described in FIG. 10.

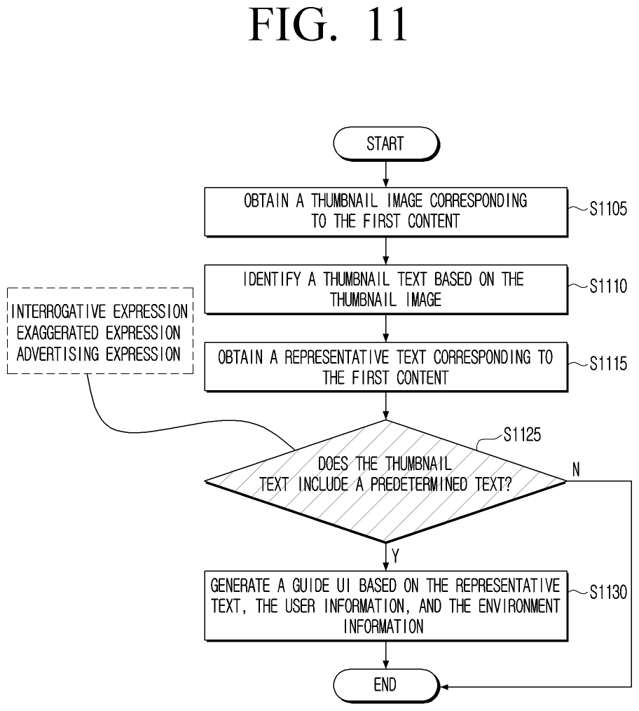

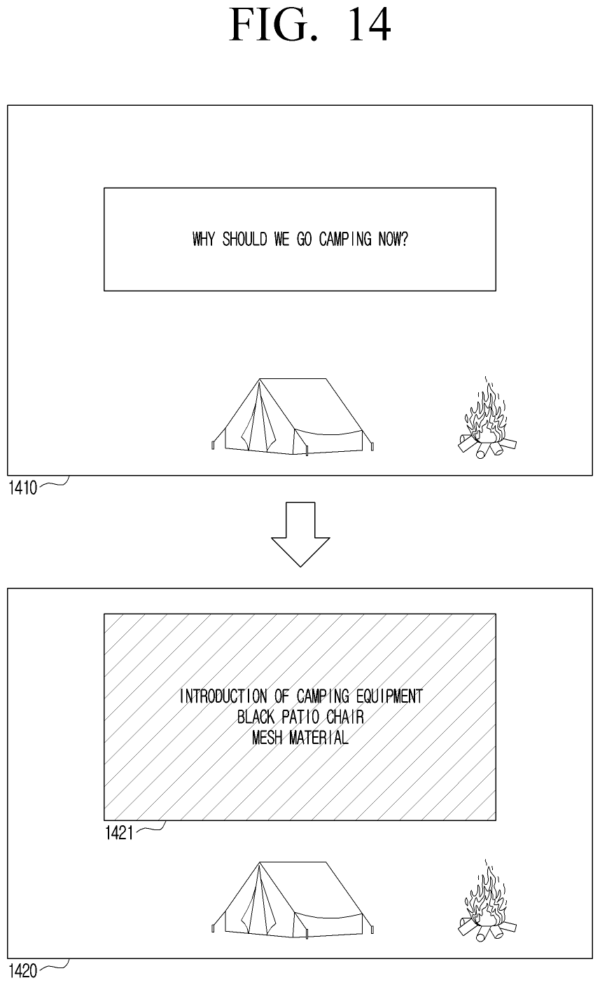

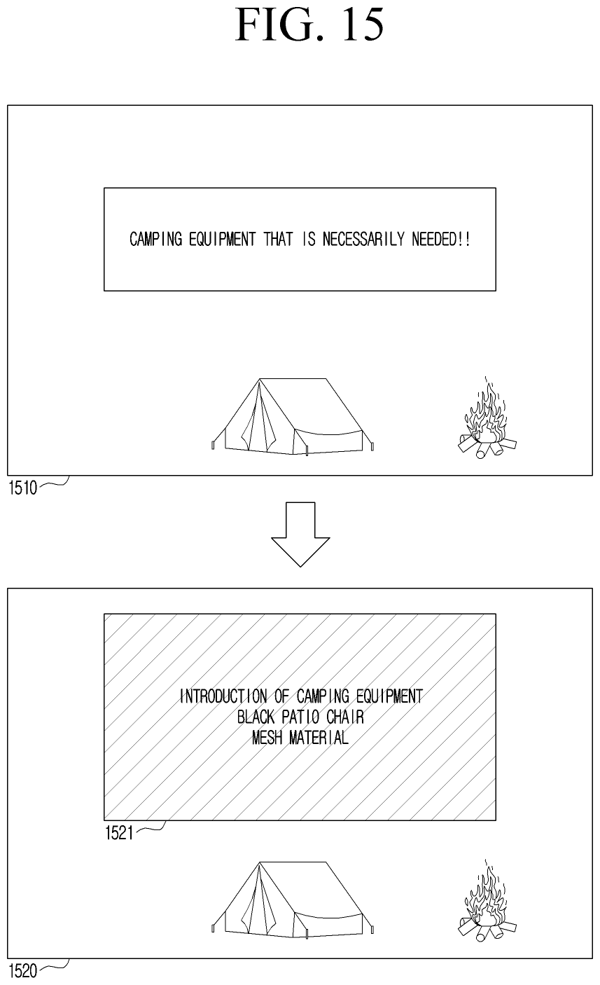

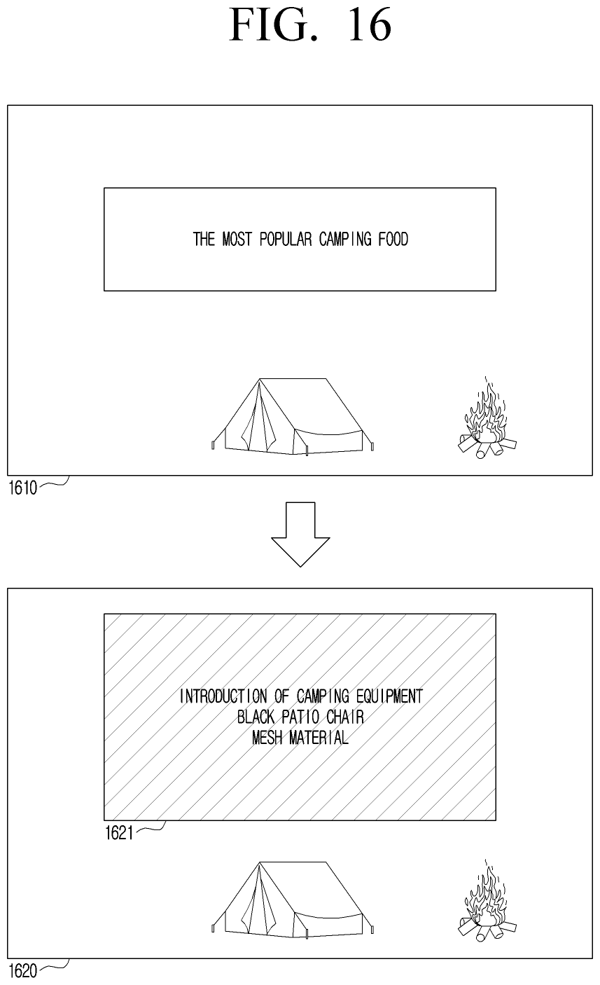

If the thumbnail text includes a predetermined text, the at least one processor 120 may generate a guide UI. The predetermined text may include at least one of an interrogative expression, an exaggerated expression, or an advertising expression. Explanation related to this will be described in FIG. 11. A content related to an interrogative expression will be described in FIG. 14. A content related to an exaggerated expression will be described in FIG. 15. A content related to an advertising expression will be described in FIG. 16.

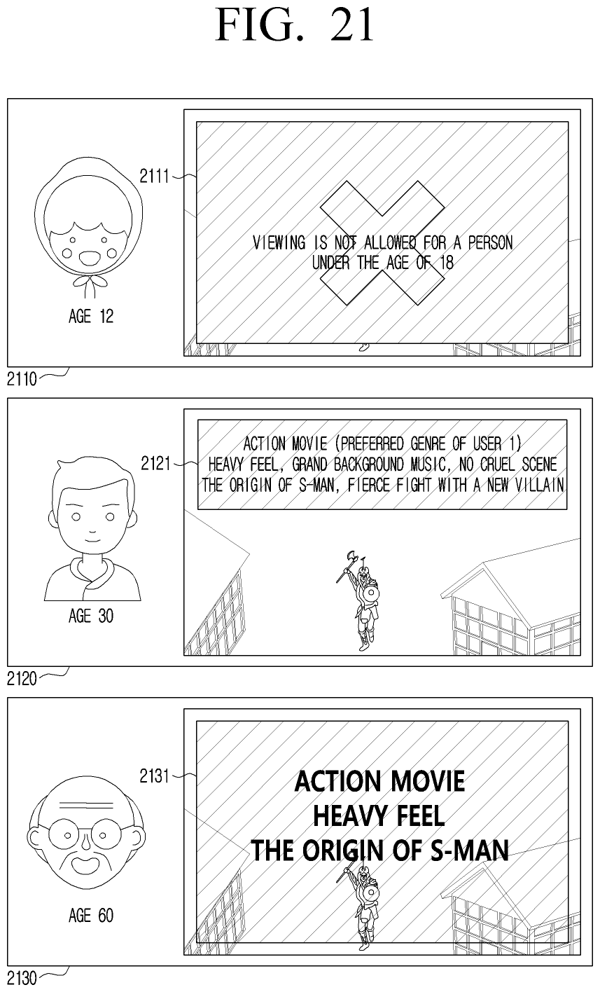

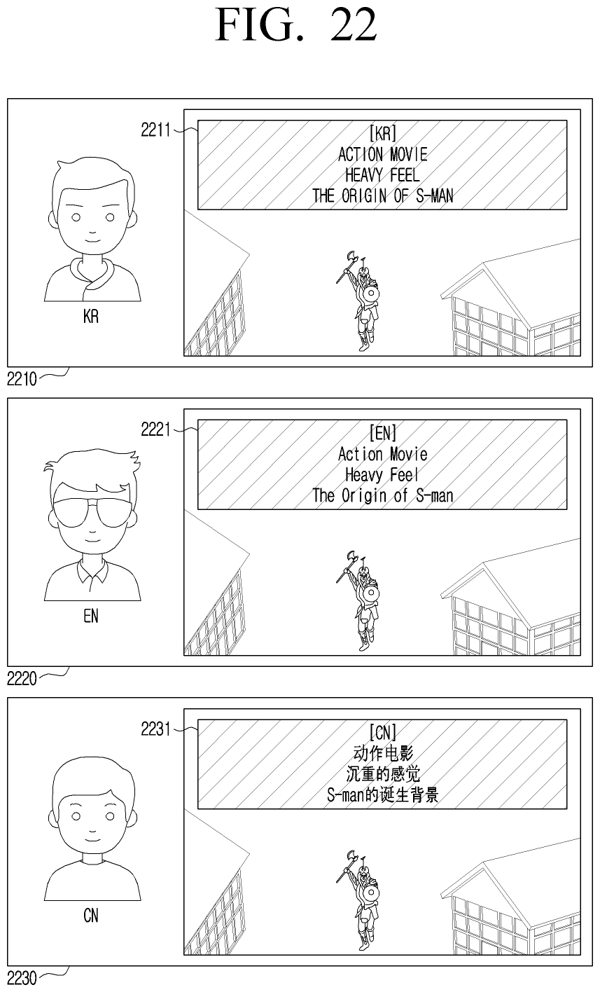

The at least one processor 120 may obtain user information including at least one of an account, a name, an age, a sex, a language, a country, health, or a preferred category. The at least one processor 120 may generate a guide UI based on the content information and the user information. An embodiment of generating a guide UI based on an age will be described in FIG. 21. An embodiment of generating a guide UI based on a country will be described in FIG. 22.

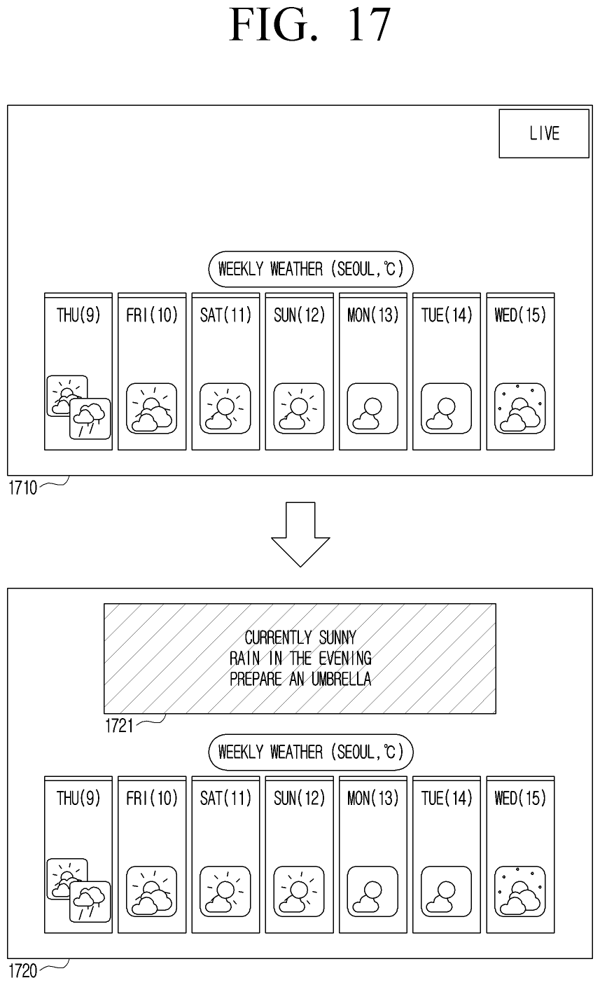

The at least one processor 120 may obtain environment information including at least one of a location, a date, or weather, and generate a guide UI based on the content information and the environment information. Explanation related to weather will be described in FIG. 17.

As an example, the at least one processor 120 may generate a guide UI based on a proverb or a four character idiom corresponding to a user's age.

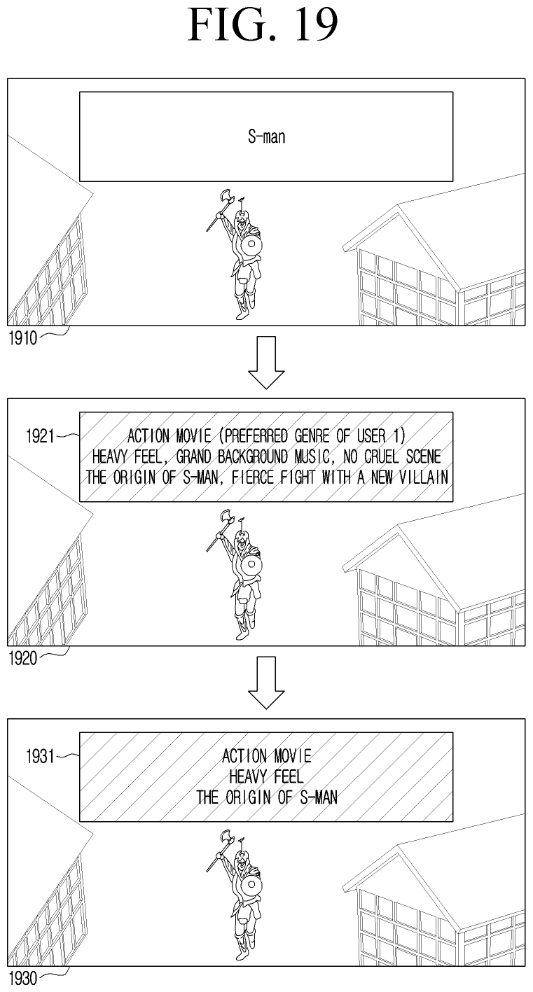

The at least one processor 120 may provide a plurality of guide UIs for one content. The at least one processor 120 may provide a first guide UI and a second guide UI corresponding to one content. As an example, if the threshold time passes from the time point when the first guide UI was displayed, the at least one processor 120 may display the second guide UI. An embodiment wherein a guide UI is changed according to the passage of time will be described in FIG. 19.

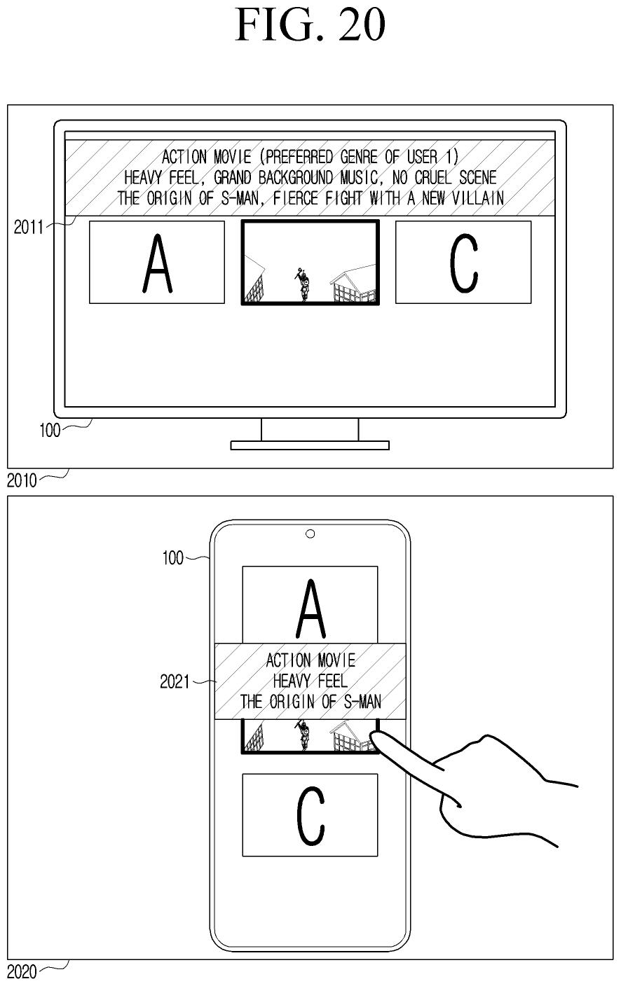

The at least one processor 120 may obtain screen information including at least one of a resolution of the display 140 or a resolution of the area wherein the first thumbnail image is displayed. The at least one processor 120 may generate a guide UI based on the content information and the screen information. A content of generating a guide UI based on the screen information will be described in FIG. 20.

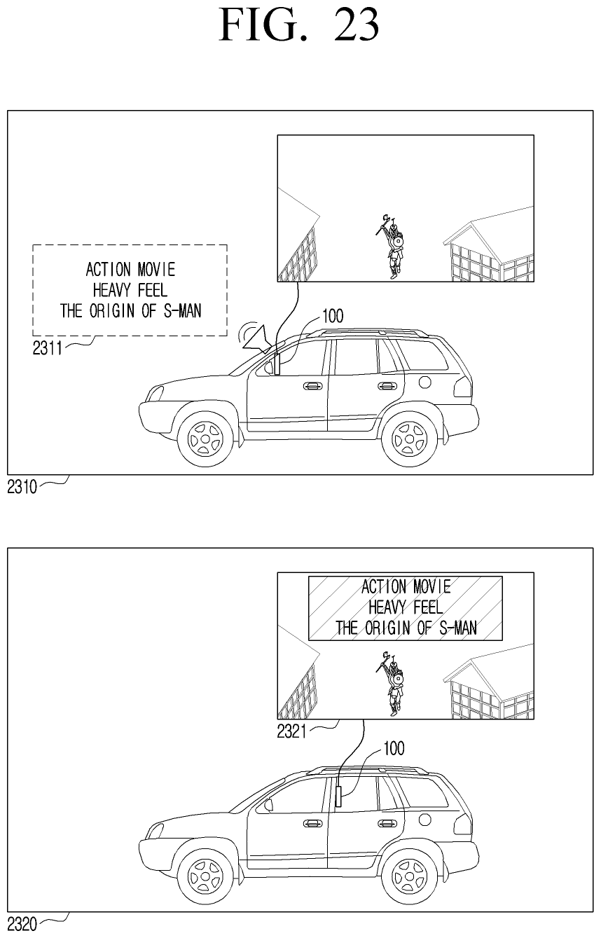

An embodiment of determining a type of a guide UI based on an arrangement location of the electronic apparatus 100 will be described in FIG. 23. FIG. 23 discloses an embodiment of providing a type of a guide UI differently according to an arrangement location of the electronic apparatus 100 arranged in a mobile vehicle.

The at least one processor 120 may determine the setting (or the display setting) related to a guide UI. The at least one processor 120 may display the guide UI based on the determined setting.

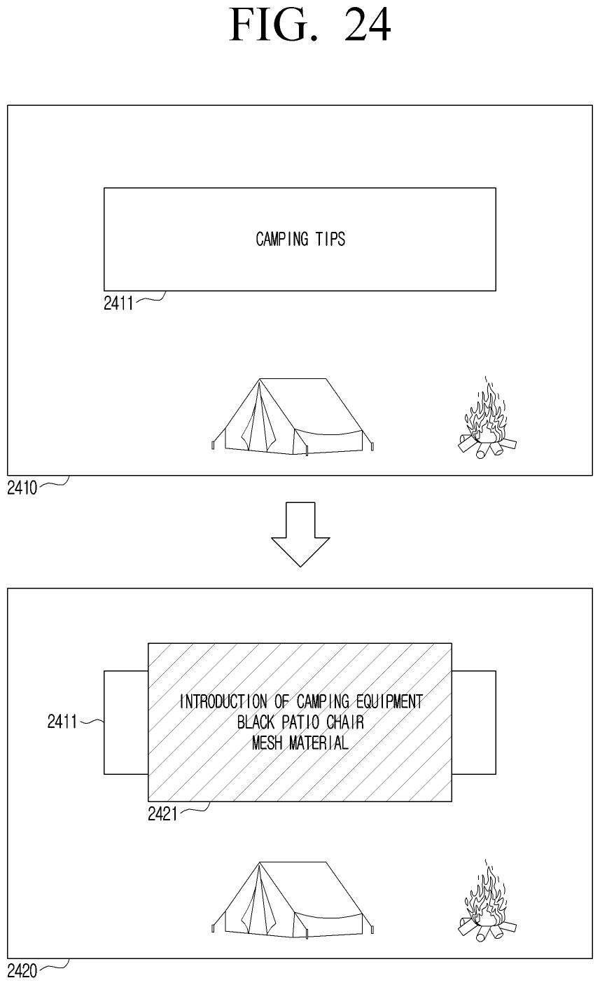

As an example, the at least one processor 120 may display a guide UI based on a location wherein the first thumbnail image is displayed on the first screen. The at least one processor 120 may control the display 140 to display the second screen including the guide UI. A content related to the display setting indicating a location or a method of displaying a guide UI will be disclosed in FIG. 24 to FIG. 28.

A thumbnail image may be an image generated by a content provider. Accordingly, a thumbnail image may be different from the topic of the actual content. The electronic apparatus 100 may directly generate a representative text based on the content information, and generate a guide UI including the representative text. As the guide UI generated by the electronic apparatus 100 includes substantial information, the user can trust the guide UI.

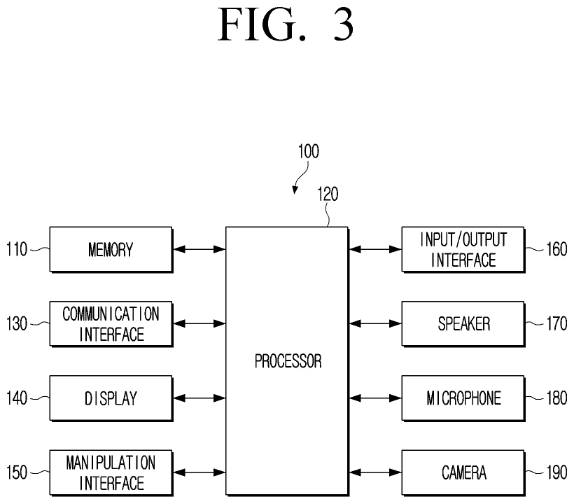

FIG. 3 is a block diagram for illustrating a detailed configuration of the electronic apparatus 100 in FIG. 2 according to an embodiment.

Referring to FIG. 3, the electronic apparatus 100 may include at least one of memory 110, at least one processor 120, a communication interface 130, a display 140, a manipulation interface 150, an input/output interface 160, a speaker 170, a microphone 180, or a camera 190.

The memory 110 may be implemented as internal memory such as ROM (e.g., electrically erasable programmable read-only memory (EEPROM)), RAM, etc., included in the at least one processor 120, or implemented as separate memory from the at least one processor 120. Also, the memory 110 may be implemented in the form of memory embedded in the electronic apparatus 100, or implemented in the form of memory that can be attached to or detached from the electronic apparatus 100 according to the use of stored data. For example, in the case of data for driving the electronic apparatus 100, the data may be stored in memory embedded in the electronic apparatus 100, and in the case of data for an extended function of the electronic apparatus 100, the data may be stored in memory that can be attached to or detached from the electronic apparatus 100.

In the case of memory embedded in the electronic apparatus 100, the memory may be implemented as at least one of volatile memory (e.g.: dynamic RAM (DRAM), static RAM (SRAM), or synchronous dynamic RAM (SDRAM), etc.) or non-volatile memory (e.g.: one time programmable ROM (OTPROM), programmable ROM (PROM), erasable and programmable ROM (EPROM), electrically erasable and programmable ROM (EEPROM), mask ROM, flash ROM, flash memory (e.g.: NAND flash or NOR flash, etc.), a hard drive, or a solid state drive (SSD)). Also, in the case of memory that can be attached to or detached from the electronic apparatus 100, the memory may be implemented in forms such as a memory card (e.g., compact flash (CF), secure digital (SD), micro secure digital (Micro-SD), mini secure digital (Mini-SD), extreme digital (xD), a multi-media card (MMC), etc.) and external memory that can be connected to a USB port (e.g., a USB memory), etc.

The memory 110 may store at least one instruction. The at least one processor 120 may perform various operations based on the instructions stored in the memory 110.

The at least one processor 120 may be implemented as a digital signal processor (DSP) processing digital signals, a microprocessor, and a time controller (TCON). However, the disclosure is not limited thereto, and the at least one processor 120 may include one or more of a central processing unit (CPU), a micro controller unit (MCU), a micro processing unit (MPU), a controller, an application processor (AP), a graphics-processing unit (GPU) or a communication processor (CP), and an advanced reduced instruction set computer (RISC) machines (ARM) processor, or may be defined by the terms. Also, the at least one processor 120 may be implemented as a system on chip (SoC) having a processing algorithm stored therein or large scale integration (LSI), or in the form of a field programmable gate array (FPGA). The at least one processor 120 may perform various functions by executing computer executable instructions stored in the memory.

The communication interface 130 is a component that performs communication with various types of external apparatuses according to various types of communication methods. The communication interface 130 may include a wireless communication module or a wired communication module. Each communication module may be implemented in a form of at least one hardware chip.

A wireless communication module may be a module that communicates with an external apparatus wirelessly. For example, a wireless communication module may include at least one module among a Wi-Fi module, a Bluetooth module, an infrared communication module, or other communication modules.

A Wi-Fi module and a Bluetooth module may perform communication by a Wi-Fi method and a Bluetooth method, respectively. In the case of using a Wi-Fi module or a Bluetooth module, various types of connection information such as a service set identifier (SSID) and a session key, etc. is transmitted and received first, and connection of communication is performed by using the information, and various types of information can be transmitted and received thereafter.

An infrared communication module performs communication according to an infrared Data Association (IrDA) technology of transmitting data to a near field wirelessly by using infrared rays between visible rays and millimeter waves.

Other communication modules may include at least one communication chip that performs communication according to various wireless communication protocols such as Zigbee, 3rd Generation (3G), 3rd Generation Partnership Project (3GPP), Long Term Evolution (LTE), LTE Advanced (LTE-A), 4th Generation (4G), 5th Generation (5G), etc. other than the aforementioned communication methods.

A wired communication module may be a module that communicates with an external apparatus via wire. For example, a wired communication module may include at least one of a local area network (LAN) module, an Ethernet module, a pair cable, a coaxial cable, an optical fiber cable, or an ultra wide-band (UWB) module.

According to an embodiment, the communication interface 130 may use the same communication module (e.g., a Wi-Fi module) for communicating with an external apparatus such as a remote control device and an external server.

According to an embodiment, the communication interface 130 may use different communication modules for communicating with an external apparatus such as a remote control device and an external server. For example, the communication interface 130 may use at least one of an Ethernet module or a Wi-Fi module for communicating with an external server, and use a Bluetooth module for communicating with an external apparatus such as a remote control device. However, this is merely an example, and the communication interface 130 may use at least one communication module among various communication modules in the case of communicating with a plurality of external apparatuses or external servers.

The display 140 may be implemented as various forms of displays such as a liquid crystal display (LCD), an organic light emitting diodes (OLED) display, a plasma display panel (PDP), etc. In the display 140, driving circuits that may be implemented in forms such as an amorphous silicon thin film transistor (a-si TFT), a low temperature poly silicon (LTPS) TFT, an organic TFT (OTFT), etc., and a backlight unit, etc. may also be included together. The display 140 may also be implemented as a touch screen combined with a touch sensor, a flexible display, a three-dimensional display (3D) display, etc. Also, the display 140 according to an embodiment of the disclosure may include not only a display panel outputting images, but also a bezel housing the display panel. In particular, a bezel according to an embodiment of the disclosure may include a touch sensor for detecting user interactions.

The manipulation (or interaction) interface 150 may be implemented as a device like a button, a touch pad, a mouse, and a keyboard, or as a touch screen that can perform both of the aforementioned display function and receive user input. A button may be various types of buttons such as a mechanical button, a touch pad, a wheel, etc. formed in any areas such as the front surface part or the side surface part, the rear surface part, etc. of the exterior of the main body of the electronic apparatus 100.

The input/output interface 160 may be any one interface among a high definition multimedia interface (HDMI), a mobile high-definition link (MHL), a universal serial bus (USB), a display port (DP), a Thunderbolt, a video graphics array (VGA) port, an RGB port, a D-subminiature (D-SUB), and a digital visual interface (DVI). The input/output interface 160 may input or output at least one of an audio signal or a video signal. Depending on implementation examples, the input/output interface 160 may include a port outputting only audio signals and a port outputting only video signals as separate ports, or it may be implemented as one port that inputs and outputs both audio signals and video signals. The electronic apparatus 100 may transmit at least one of an audio signal or a video signal to an external apparatus (e.g., an external display apparatus or an external speaker) through the input/output interface 160. An output port included in the input/output interface 160 may be connected with an external apparatus, and the electronic apparatus 100 may transmit at least one of an audio signal or a video signal to the external apparatus through the output port.

The input/output interface 160 may be connected with the communication interface. The input/output interface 160 may transmit information received from an external apparatus to the communication interface, or transmit information received through the communication interface to an external apparatus.

The speaker 170 may be a component that outputs not only various types of audio data, but also various types of notification sounds or voice messages, etc.

The microphone 180 is a component for receiving input of a user voice or other sounds, and converting them into audio data. The microphone 180 may receive a user's voice in an activated state. For example, the microphone 180 may be formed as an integrated type integrated to the upper side or the front surface direction, the side surface direction, etc. of the electronic apparatus 100. The microphone 180 may include various components such as a microphone collecting a user voice in an analog form, an amp circuit amplifying the collected user voice, an A/D conversion circuit that samples the amplified user voice and converts the user voice into a digital signal, a filter circuit that removes noise components from the converted digital signal, etc.

The camera 190 is a component for photographing a subject and generating a photographed image, and a photographed image is a concept including both of a moving image and a still image. The camera 190 may obtain an image for at least one external apparatus, and may be implemented as a camera, a lens, an infrared sensor, etc.

The camera 190 may include a lens and an image sensor. As types of lenses, there are a general generic-purpose lens, a wide-angle lens, a zoom lens, etc., and the type may be determined according to the type, the characteristic, the use environment, etc. of the electronic apparatus 100. As the image sensor, a complementary metal oxide semiconductor (CMOS) and a charge coupled device (CCD), etc. may be used.

FIG. 4 is a diagram for illustrating a guide UI generation model according to an embodiment.

Referring to FIG. 4, the electronic apparatus 100 may obtain a guide UI based on a guide UI generation model 400.

According to an embodiment, the electronic apparatus 100 may store the guide UI generation model 400. The electronic apparatus 100 may store the guide UI generation model 400 in the memory 110 by an on-device method. The electronic apparatus 100 may obtain a guide UI by using the stored guide UI generation model 400.

According to an embodiment, the guide UI generation model 400 may be stored in a server. The electronic apparatus 100 may request a guide UI to the server. The electronic apparatus 100 may receive the guide UI generated by the guide UI generation model 400 from the server.

The guide UI generation model 400 may receive at least one of the content information, the user information, the environment information, or the screen information as input data.

The content information may indicate information related to a content that can be selected by a user. The content information may include at least one of image data, audio data, thumbnail data, or metadata.

The image data may indicate images indicating contents.

The audio data may indicate audio indicating contents.

The thumbnail data may include thumbnail images or thumbnail texts explaining contents. As an example, texts may be included in thumbnail images.

The metadata may include information related to contents. The metadata may be data generated in advance in a source device providing contents. The source device may be a content providing server. As an example, the metadata may include at least one of a title, a drafter, a provider, cast, story summary, a resolution, a codec, or an age restriction for viewing.

The user information may include information related to a user. Also, the user information may include identification information for identifying a user or personal information related to a user. As an example, the user information may include at least one of an account, a name, an age, a sex, a language, a country, health, or a preferred category.

The environment information may indicate information on the electronic apparatus 100 or an environment related to a user. The environment may include information related to the surrounding environment of the current location of the electronic apparatus 100. The surrounding environment may be changed according to the user's setting. As an example, the environment information may include at least one of a location, a date, or weather.

The screen information may indicate the size of an area wherein a guide UI is displayed. Also, the screen information may include a resolution. The screen information may include at least one of a resolution (or a size) of an entire area including a guide UI or a resolution (or a size) of a thumbnail area. A thumbnail area may be an area wherein a thumbnail of a resolution is displayed.

A guide UI may be output in various ways.

As an example, a guide UI may be output through a display device. A resolution may indicate a size that can be displayed on the display. Also, a resolution may include at least one of a resolution of an entire area wherein the display device can display an image or a resolution of a thumbnail area displaying a thumbnail image.

As an example, a guide UI may be output on a projection surface. The electronic apparatus 100 performing a projector function may output a projection image including a guide UI on a projection surface. The guide UI generation model 400 may receive the resolution (or the size) of the projection surface.

The guide UI generation model 400 may generate a guide UI based on at least one of the content information, the user information, the environment information, or the screen information.

The guide UI generation model 400 may obtain a representative text of a content based on image data and audio data included in the content information. The guide UI generation model 400 may identify whether a thumbnail is appropriate for a content based on the thumbnail data included in the content information. The guide UI generation model 400 may identify a representative text based on the metadata included in the content information. Explanation related to this will be described in FIG. 10.

The guide UI generation model 400 may generate a guide UI based on the user information.

As an example, the guide UI generation model 400 may generate a guide UI including the user's name.

As an example, the guide UI generation model 400 may generate a guide UI by using a word (or a text size) appropriate for the age of the user.

As an example, the guide UI generation model 400 may generate a guide UI by using a color (or a word) appropriate for the sex of the user.

As an example, the guide UI generation model 400 may generate a guide UI based on the user's language.

As an example, the guide UI generation model 400 may generate a guide UI based on the language corresponding to the user's country.

As an example, the guide UI generation model 400 may generate a guide UI in consideration of the user's health (or health information). The guide UI generation model 400 may generate a guide UI such that information related to the user's health is included.

As an example, the guide UI generation model 400 may generate a guide UI based on the user's preferred category. The guide UI generation model 400 may generate the guide UI in a first color. In case a content of the same category as the preferred category is selected, the guide UI generation model 400 may generate the guide UI in a second color different from the first color.

As an example, the guide UI generation model 400 may generate a guide UI including a text indicating the current location based on the location included in the environment information.

As an example, the guide UI generation model 400 may generate a guide UI including a text indicating the date included in the environment information.

As an example, the guide UI generation model 400 may generate a guide UI including a text indicating the weather included in the environment information.

As an example, the guide UI generation model 400 may generate a guide UI based on the resolution included in the screen information. The guide UI generation model 400 may determine the size of the guide UI based on the resolution. The size of the guide UI may include at least one of the size of the area wherein the guide UI is displayed or the size of the text included in the guide UI.

FIG. 5 is a flowchart illustrating an operation of generating a guide UI according to an embodiment.

Referring to FIG. 5, the electronic apparatus 100 may display (or provide) a plurality of thumbnail images for a plurality of contents in the operation S510. The electronic apparatus 100 may receive a user input selecting the first thumbnail image of the first content among the plurality of thumbnail images in the operation S520.

As an example, the electronic apparatus 100 may be a TV. The electronic apparatus 100 may be communicatively connected with a remote control device that can control the electronic apparatus 100. The electronic apparatus 100 may receive a user input from the remote control device.

As an example, the electronic apparatus 100 may be a smart device. The electronic apparatus 100 may receive a user's touch input (a touch by a hand or a touch by a smart pen).

The electronic apparatus 100 may obtain at least one of content information, user information, environment information, or screen information in the operation S530.

The electronic apparatus 100 may generate a guide UI based on at least one of the content information, the user information, the environment information, or the screen information in the operation S540.

As an example, the electronic apparatus 100 may generate the guide UI by using only the content information.

As an example, the electronic apparatus 100 may generate the guide UI by using the content information and the user information.

As an example, the electronic apparatus 100 may generate the guide UI by using the content information and the environment information.

As an example, the electronic apparatus 100 may generate the guide UI by using the content information and the screen information.

As an example, the electronic apparatus 100 may generate the guide UI by using the content information, the user information, and the environment information.

As an example, the electronic apparatus 100 may generate the guide UI by using the content information, the user information, and the screen information.

As an example, the electronic apparatus 100 may generate the guide UI by using the content information, the environment information, and the screen information.

As an example, the electronic apparatus 100 may generate the guide UI by using the content information, the user information, the environment information, and the screen information.

The electronic apparatus 100 may identify a predetermined user input for the first content among the plurality of thumbnail images in the operation S550. The predetermined user input may indicate a user input that was set in advance. Also, the predetermined user input may include a pattern of the predetermined user input.

As an example, the predetermined user input may include an input for selecting a specific content during a threshold time or longer. Also, the predetermined user input may include an input pattern of selecting a specific content, and not selecting another content during the threshold time or longer.

An input for selecting a specific content during the threshold time or longer may indicate an input for the activation UI to be displayed on the specific content during the threshold time or longer.

Also, an input for selecting a specific content during the threshold time or longer may indicate an input of touching the specific content during the threshold time or longer.

As an example, the predetermined user input may include a user input selecting a specific content through a specific key. Also, the predetermined user input may include an input selecting a specific content through a specific key among a plurality of keys included in the interaction interface of the electronic apparatus 100.

As an example, the predetermined user input may include a user input by which the first content is selected in a specific mode. The specific mode may be a mode of displaying the guide UI.

As an example, the predetermined user input may include an input of stopping a touch drag on a location of a specific content during the threshold time or longer.

According to an embodiment, the operation of identifying whether the predetermined user input is received in the operation S550 may be described as an operation of identifying whether a predetermined event occurs.

If the predetermined user input is identified in the operation S550—Y, the electronic apparatus 100 may display (or provide) the guide UI in the operation S560. If the predetermined user input is not identified in the operation S550—N, the electronic apparatus 100 may display the plurality of thumbnail images for the plurality of contents in the operation S510.

Referring to the embodiment in FIG. 5, the electronic apparatus 100 may generate a guide UI in advance, and determine whether the predetermined user input is identified in a state wherein the guide UI was generated. This is for the electronic apparatus 100 to immediately display (or provide) the first content if the predetermined user input is identified. In the case of generating the guide UI when the predetermined user input is received, time for processing may be needed.

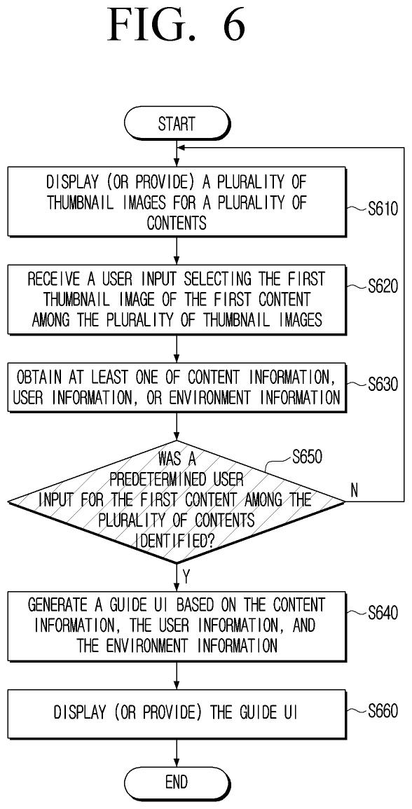

FIG. 6 is a flowchart illustrating an operation of generating a guide UI if a predetermined user input is identified according to an embodiment.

The operations S610, S620, S630, S640, S650, and S660 in FIG. 6 may correspond to the operations S510, S520, S530, S540, S550, and S560 in FIG. 5. Accordingly, overlapping explanation will be omitted.

Unlike in FIG. 5, in the embodiment in FIG. 6, the operation of identifying the predetermined user input (e.g., operation S650) may be generated before the operation of generating the guide UI (e.g., operation S640). In a state wherein at least one of the content information, the user information, the environment information, or the screen information was received, the electronic apparatus 100 may determine whether the predetermined user input is identified. The electronic apparatus 100 may generate the guide UI in case the predetermined user input was identified.

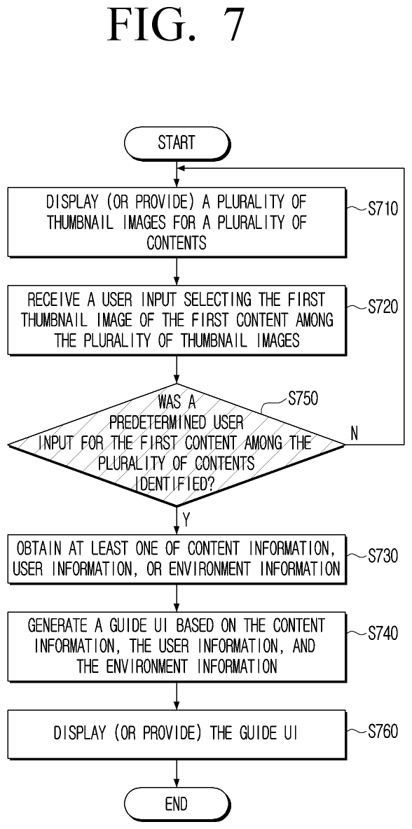

FIG. 7 is a flowchart illustrating an operation of obtaining at least one of content information, user information, environment information, or screen information if a predetermined user input is identified according to an embodiment.

The operations S710, S720, S730, S740, S750, and S760 in FIG. 7 may correspond to the operations S510, S520, S530, S540, S550, and S560 in FIG. 5. Accordingly, overlapping explanation will be omitted.

Unlike in FIG. 5, in the embodiment in FIG. 7, the operation of identifying the predetermined user input (e.g., operation S750) may be performed before the operation of receiving at least one of the content information, the user information, the environment information, or the screen information (e.g., operation S730).

The electronic apparatus 100 may receive at least one of the content information, the user information, the environment information, or the screen information limited to a case of identifying the predetermined user input in the operation S730, and generate the guide UI in the operation S740.

This is because there is a high probability of storing unnecessary information in the case of receiving at least one of the content information, the user information, the environment information, or the screen information before identifying the predetermined user input. Even if the time taken for generating the guide UI becomes longer than in the embodiment in FIG. 5 and in the embodiment in FIG. 6, the electronic apparatus 100 may receive at least one of the content information, the user information, the environment information, or the screen information after identifying the predetermined user input.

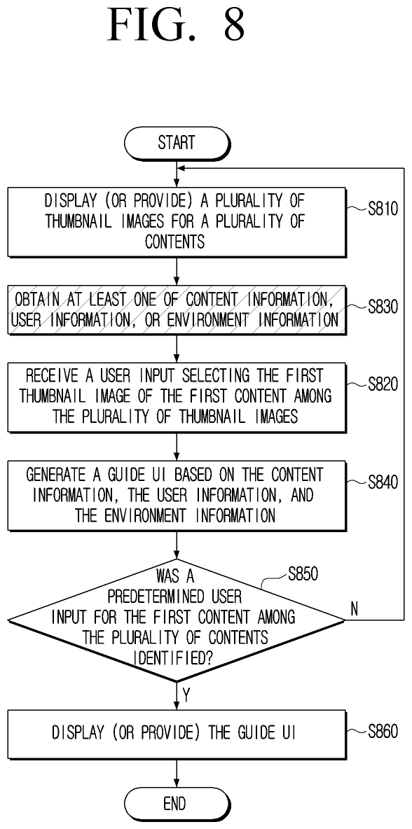

FIG. 8 is a flowchart illustrating an operation of obtaining at least one of content information, user information, environment information, or screen information before a user input selecting a first thumbnail image of a first content is received according to an embodiment.

The operations S810, S820, S830, S840, S850, and S860 in FIG. 8 may correspond to the operations S510, S520, S530, S540, S550, and S560 in FIG. 5. Accordingly, overlapping explanation will be omitted.

Unlike in FIG. 5, in the embodiment in FIG. 8, the operation of receiving at least one of the content information, the user information, the environment information, or the screen information (e.g., operation S830) may be performed before the operation of receiving a user input selecting the first thumbnail image of the first content (e.g., operation S820).

After the operation of displaying a plurality of contents (e.g., operation S810), the electronic apparatus 100 may immediately receive at least one of the content information, the user information, the environment information, or the screen information. This is for reducing the generation time of the guide UI by receiving information for generating the guide UI in advance.

FIG. 9 is a flowchart illustrating an operation of generating a guide UI according to a predetermined event according to an embodiment.

The operations S910, S920, S930, S940, S950, and S960 in FIG. 9 may correspond to the operations S510, S520, S530, S540, S550, and S560 in FIG. 5. Accordingly, overlapping explanation will be omitted.

After receiving at least one of the content information, the user information, the environment information, or the screen information, the electronic apparatus 100 may determine whether a predetermined event is identified for the first content among the plurality of thumbnail images in the operation S935.

As an example, the predetermined event may indicate an event wherein it is identified that the topic of the content and the thumbnail do not coincide. The electronic apparatus 100 may determine the topic of the content based on the explanation provided in the content. The topic may be described as summary information. Also, the topic may include a representative text. The electronic apparatus 100 may determine whether the topic of the content coincides with the thumbnail. In case the topic of the content does not coincide with the thumbnail, the electronic apparatus 100 may determine to provide a new thumbnail. Detailed explanation related to this will be described in FIG. 11.

As an example, the predetermined event may include an event wherein it is identified that the thumbnail includes a predetermined word (or sentence). The predetermined word may include at least one of an interrogative expression, an exaggerated expression, or an advertising expression. Detailed explanation related to this will be described in FIG. 12.

If the predetermined event for the first content among the plurality of thumbnail images is identified in the operation S935—Y, the electronic apparatus 100 may receive at least one of the content information, the user information, the environment information, or the screen information in the operation S940. Then, the electronic apparatus 100 may perform the operations S950 and S960. If the predetermined event for the first content among the plurality of thumbnail images is not identified in the operation S935—N, the electronic apparatus 100 may move to operation S910.

As an example, the operation S935 may be performed after the operation S940.

As an example, the operation S935 may be performed after the operation S950.

FIG. 10 is a flowchart illustrating an operation of comparing a representative text and a thumbnail text according to an embodiment.

Referring to FIG. 10, the electronic apparatus 100 may obtain a thumbnail image corresponding to the first content in the operation S1005. The electronic apparatus 100 may extract the thumbnail image in an area wherein the thumbnail image corresponding to the first content is displayed. The electronic apparatus 100 may identify a thumbnail text based on the thumbnail image in the operation S1010.

The electronic apparatus 100 may identify a thumbnail text by analyzing the thumbnail image. The electronic apparatus 100 may identify a text included in the thumbnail image.

As an example, the electronic apparatus 100 may obtain a thumbnail text by using optical character recognition (OCR).

As an example, the electronic apparatus 100 may obtain a thumbnail text by using automatic content recognition (ACR).

As an example, the electronic apparatus 100 may obtain a thumbnail text by using a text extraction model. The text extraction model may be an artificial intelligence model, and include an algorithm extracting a text from an image.

A thumbnail text may not be included in the thumbnail image. The electronic apparatus 100 may identify an object corresponding to the thumbnail image, and identify a text indicating the identified object as a thumbnail text.

As an example, a text itself may not be included in the thumbnail image, but simply an apple image (or object) may be included. The electronic apparatus 100 may identify the thumbnail text as ‘an apple’ based on the apple image (or object) included in the thumbnail image.

The electronic apparatus 100 may obtain a representative text corresponding to the first content in the operation S1015. The representative text may be a text indicating the first content. The representative text may include summary information explaining the first content. Also, the representative text may include information indicating the topic of the first content.

As an example, the electronic apparatus 100 may obtain a representative text based on image data included in the content information.

As an example, the electronic apparatus 100 may obtain a representative text based on audio data included in the content information.

The electronic apparatus 100 may receive content information related to the first content from the background environment while displaying the thumbnail of the first content. The electronic apparatus 100 may obtain at least one of image data or audio data from the received content information. The electronic apparatus 100 may obtain a representative text based on at least one of the image data or the audio data.

As an example, the electronic apparatus 100 may obtain a representative text based on metadata included in the content information. The electronic apparatus 100 may obtain a representative text based on at least one of the title or the story summary included in the metadata.

The electronic apparatus 100 may obtain a representative text of the first content based on the content information. The electronic apparatus 100 may obtain a representative text of the first content based on at least one of the image data of the first content, the audio data of the first content, or the metadata of the first content.

The representative text may be information that is generated automatically, but not by the drafter who made the first content. The thumbnail may include information not related to the actual details of the content. However, the representative text may match the actual details of the content. Accordingly, if a guide UI is generated by using the representative text, more correct information can be provided to the user.

The electronic apparatus 100 may obtain (or calculate) the similarity between the representative text and the thumbnail text in the operation S1020. The electronic apparatus 100 may identify whether the similarity is smaller than a threshold value in the operation S1025. The similarity may be a concept including the similarity of words themselves and the similarity of the meaning of the words through text comparison. The electronic apparatus 100 may identify whether the thumbnail coincides with the topic of the content by comparing the representative text and the thumbnail text. The threshold value may be changed according to the user's setting.

If the similarity is smaller than the threshold value in the operation S1025—Y, the electronic apparatus 100 may generate a guide UI based on at least one of the representative text, the user information, the environment information, or the screen information in the operation S1030.

In case the similarity is smaller than the threshold value, the electronic apparatus 100 may identify that the thumbnail does not match the topic of the content. If the thumbnail does not coincide with the actual topic of the content, it may interfere with the user in selecting the content. The electronic apparatus 100 can provide correct information to the user who selects the content by displaying a new guide UI.

FIG. 11 is a flowchart illustrating an operation of determining whether a thumbnail text includes a predetermined text according to an embodiment.

The operations S1105, S1110, S1115, and S1130 in FIG. 11 may correspond to the operations S1005, S1010, S1015, and S1030 in FIG. 10. Accordingly, overlapping explanation will be omitted.

After obtaining a representative text, the electronic apparatus 100 may identify whether the thumbnail text includes a predetermined text in the operation S1125. The predetermined text may include a text which becomes a standard for identifying a predetermined event for generating a guide UI. According to whether the thumbnail text includes the predetermined text, the electronic apparatus 100 may determine whether to generate a guide UI.

As an example, the predetermined text may include at least one of an interrogative expression, an exaggerated expression, or an advertising expression. The predetermined text may include at least one expression (or word or sentence) set in advance. The predetermined text may be changed (or updated) by the user.

As an example, a predetermined text indicating an interrogative expression may include at least one of where, when, why, what, who, how, how many, which, and how much. Also, the predetermined text indicating an interrogative expression may include a question mark symbol.

As an example, a predetermined text indicating an exaggerated expression may include at least one of the best, the highest, the maximum, the superior, the first, the strongest, the highest class, the most, more than anything, necessarily, or essential.

As an example, a predetermined text indicating an advertising expression may include at least one of popular, free, special, limited, new, expected, immediate, cheap, effective, or perfect.

If the thumbnail text includes the predetermined text in the operation S1125—Y, the electronic apparatus 100 may generate a guide UI based on at least one of the representative text, the user information, the environment information, or the screen information in the operation S1130.

FIG. 12 is a diagram for illustrating an operation of selecting a first thumbnail image of a first content according to an embodiment.

Referring to the embodiment 1210 in FIG. 12, the electronic apparatus 100 may be communicatively connected with the remote control device that can control the electronic apparatus 100. The electronic apparatus 100 may receive a user input from the remote control device. If a user input selecting a specific content (a B content) is received from the remote control device, the electronic apparatus 100 may display the activation UI 10 in the area wherein the B content (or the thumbnail of the B content) is displayed.

Referring to the embodiment 1220 in FIG. 12, the electronic apparatus 100 may directly receive a user input. The electronic apparatus 100 may receive a user input of touching the display 140 of the electronic apparatus 100. The electronic apparatus 100 may directly receive a user input selecting a specific content (the B content). When the user input selecting the specific content (the B content) is received, the electronic apparatus 100 may display the activation UI 10 in the area wherein the B content (or the thumbnail of the B content) is displayed.

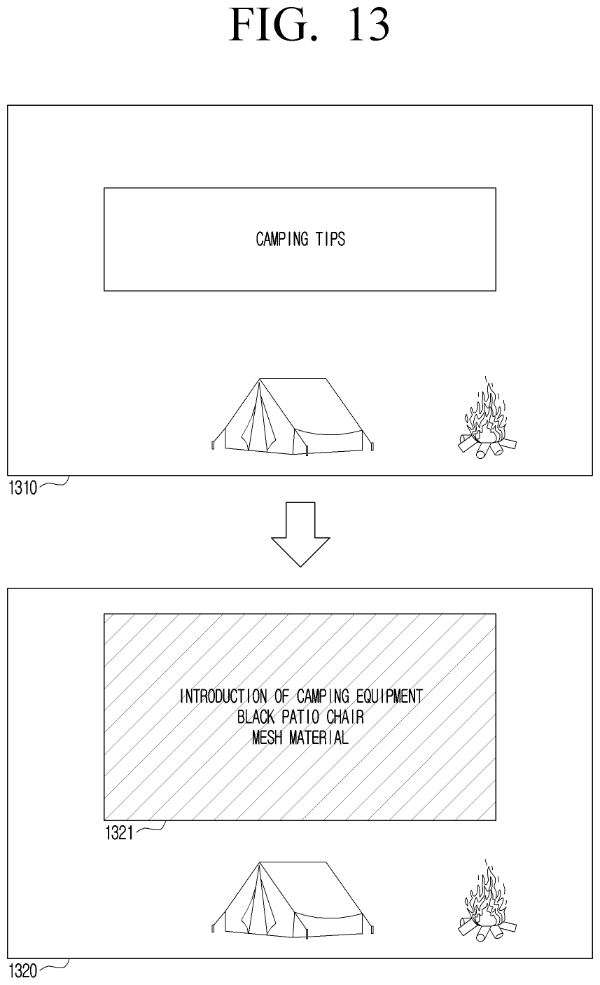

FIG. 13 is a diagram for illustrating an operation of generating a guide UI according to an embodiment.

Referring to the embodiment 1310 in FIG. 13, the electronic apparatus 100 may display a thumbnail image of a content selected by the user. The thumbnail image may include a thumbnail text which is ‘camping tips.’

Referring to the embodiment 1320 in FIG. 13, the electronic apparatus 100 may display a guide UI 1321. The electronic apparatus 100 may generate the guide UI 1321 based on at least one of the content information, the user information, the environment information, or the resolution information.

As an example, the electronic apparatus 100 may obtain a representative text by analyzing the content information. The electronic apparatus 100 may obtain a representative text including ‘introduction of camping equipment,’ ‘black patio chair,’ and ‘mesh material’ by analyzing the content information. The electronic apparatus 100 may display the guide UI 1321 including the representative text.

FIG. 14 is a diagram for illustrating an operation of generating a guide UI in case a thumbnail text includes an interrogative expression according to an embodiment.

Referring to the embodiment 1410 in FIG. 14, the electronic apparatus 100 may obtain a thumbnail text in a thumbnail image. The electronic apparatus 100 may identify an interrogative expression (Why should we go camping now?) in the thumbnail text.

Referring to the embodiment 1420 in FIG. 14, if an interrogative expression is identified in the thumbnail text, the electronic apparatus 100 may generate a guide UI 1421. Explanation related to a representative text included in the guide UI 1421 was described in FIG. 13. Accordingly, overlapping explanation will be omitted.

FIG. 15 is a diagram for illustrating an operation of generating a guide UI in case a thumbnail text includes an exaggerated expression according to an embodiment.

Referring to the embodiment 1510 in FIG. 15, the electronic apparatus 100 may obtain a thumbnail text in a thumbnail image. The electronic apparatus 100 may identify an exaggerated expression (camping equipment that is necessarily needed) in the thumbnail text. In case a predetermined text is included in the thumbnail text, the electronic apparatus 100 may identify that an exaggerated expression is included in the thumbnail image. The predetermined text for identifying an exaggerated expression may include ‘necessarily.’

Referring to the embodiment 1520 in FIG. 15, if an exaggerated expression is identified in the thumbnail text, the electronic apparatus 100 may generate a guide UI 1521. Explanation related to a representative text included in the guide UI 1521 was described in FIG. 13. Accordingly, overlapping explanation will be omitted.

FIG. 16 is a diagram for illustrating an operation of generating a guide UI in case a thumbnail text has no relevance to an image according to an embodiment.

Referring to the embodiment 1610 in FIG. 16, the electronic apparatus 100 may display a thumbnail image of a content. The electronic apparatus 100 may obtain a thumbnail text in the thumbnail image. The electronic apparatus 100 may identify an advertising expression (camping equipment that is necessarily needed) in the thumbnail text. In case a predetermined text is included in the thumbnail text, the electronic apparatus 100 may identify that an advertising expression is included in the thumbnail image. The predetermined text for identifying an advertising expression may include ‘popular.’

Referring to the embodiment 1620 in FIG. 16, if an advertising expression is identified in the thumbnail text, the electronic apparatus 100 may generate a guide UI 1621. Explanation related to a representative text included in the guide UI 1621 was described in FIG. 13. Accordingly, overlapping explanation will be omitted.

FIG. 17 is a diagram for illustrating an operation of generating a guide UI for a real time content according to an embodiment.

Referring to the embodiment 1710 in FIG. 17, the electronic apparatus 100 may display a thumbnail image of a real time weather content. The electronic apparatus 100 may receive content information corresponding to the thumbnail image. The electronic apparatus 100 may identify the category of the content based on the content information. The electronic apparatus 100 may identify whether the content category is a real time content.

If the content category is a real time content, the electronic apparatus 100 may obtain environment information. The environment information may include at least one of a location, a date, or weather.

As an example, the electronic apparatus 100 may receive environment information in advance, and store it. If the content category is identified as a real time content, the electronic apparatus 100 may obtain (or call) the pre-stored environment information.

As an example, if the content category is identified as a real time content, the electronic apparatus 100 may request environment information to an external server. The external server may transmit the environment information to the electronic apparatus 100 in response to the request of the electronic apparatus 100. The electronic apparatus 100 may receive the environment information from the external server.

Referring to the embodiment 1720 in FIG. 17, if the content category is a real time weather content, the electronic apparatus 100 may generate a guide UI 1721 based on the weather included in the environment information. The environment information may include at least one of the current weather (currently sunny) or the predicted weather (rain in the evening).

As an example, the electronic apparatus 100 may display the guide UI 1721 including the weather included in the environment information and a guiding operation. The guiding operation may include information provided to the user related to the weather (prepare an umbrella).

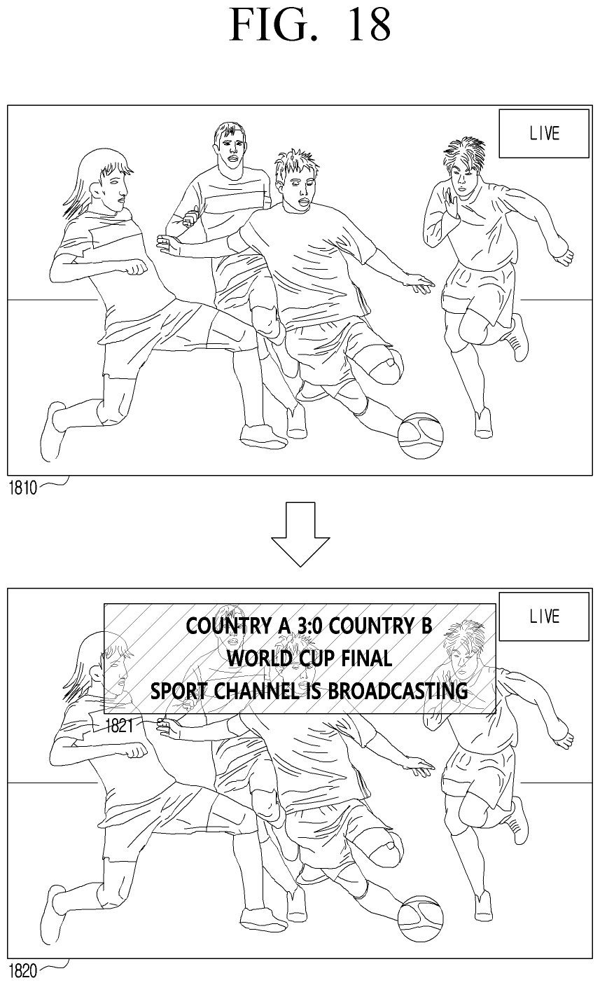

FIG. 18 is a diagram for illustrating an operation of generating a guide UI for a sport content according to an embodiment.

Referring to the embodiment 1810 in FIG. 18, the electronic apparatus 100 may display a thumbnail image of a real time sport content. The electronic apparatus 100 may receive content information corresponding to the thumbnail image. The electronic apparatus 100 may identify the category of the content based on the content information. The electronic apparatus 100 may determine whether the content category is a real time sport content.

If the content category is a real time sport content, the electronic apparatus 100 may obtain sport broadcasting information. The sport broadcasting information may include at least one of team information, score information, game information, or the broadcasting company related to the sport game.

As an example, the electronic apparatus 100 may receive the sport broadcasting information together with the thumbnail image of the content. The sport broadcasting information may be included in the metadata.

Referring to the embodiment 1820 in FIG. 18, the electronic apparatus 100 may display a guide UI 1821 including sport broadcasting information. As an example, the sport broadcasting information may include at least one of team information (the country A, the country B), score information (3:0), or the broadcasting company (Sport Channel).

FIG. 19 is a diagram for illustrating an operation of generating a plurality of guide UIs for one content according to an embodiment.

Referring to the embodiment 1910 in FIG. 19, the electronic apparatus 100 may display a thumbnail image of a content. The electronic apparatus 100 may display the thumbnail image including a text (e.g., S-man).

Referring to the embodiment 1920 in FIG. 19, the electronic apparatus 100 may display a first guide UI 1921 based on the content information. The first guide UI 1921 may include text information including words of a first number. When a first threshold time passes from the time point when the content was selected, the electronic apparatus 100 may display the first guide UI 1921.

Referring to the embodiment 1930 in FIG. 19, the electronic apparatus 100 may display a second guide UI 1931 based on the content information. The second guide UI 1931 may include text information including words of a second number. When a second threshold time passes from the time point when the first guide UI 1921 was displayed, the electronic apparatus 100 may display the second guide UI 1931.

As an example, the first number may be bigger than the second number. The electronic apparatus 100 may display the guide UI wherein the number of the words is smaller as the time passes. FIG. 19 may indicate an embodiment wherein the number of the words included in the guide UI becomes smaller as the time passes.

As an example, the first number may be smaller than the second number. The electronic apparatus 100 may display the guide UI wherein the number of the words is bigger as the time passes. If the thumbnail of the content is selected during a long time by the user's selection, the electronic apparatus 100 may display the guide UI providing more and more information.

As an example, the first threshold time and the second threshold time may be identical.

As an example, the first threshold time may be longer than the second threshold time.

As an example, the first threshold time may be shorter than the second threshold time.

FIG. 20 is a diagram for illustrating an operation of generating a guide UI according to a resolution according to an embodiment.

The electronic apparatus 100 may display a guide UI based on the screen information. The screen information may include resolution information. The resolution information may include at least one of a resolution of the display wherein the guide UI is displayed or a resolution of an area wherein a thumbnail image of a content selected by the user is displayed.

The resolution of the display may indicate the size of the entire area of the displayed screen.

The resolution of the area wherein the thumbnail image is displayed may indicate the size of a partial area wherein the thumbnail image is displayed in the entire area of the displayed screen.

As an example, the guide UI may be displayed in the entire area of the screen.

As an example, the guide UI may be displayed in the partial area wherein the thumbnail image is displayed.

The electronic apparatus 100 may determine the display setting related to the guide UI based on the screen information. The display setting related to the guide UI may include at least one of the text size or the number of the words of the text. The electronic apparatus 100 may determine at least one of the text size or the number of the words of the text based on the resolution information.

The electronic apparatus 100 may display the guide UI based on the size of the entire area of the screen. The electronic apparatus 100 may determine the size, the location, the text size, and the number of the words of the text of the guide UI in consideration of the size of the entire area of the screen.

The size may indicate the size of the area wherein the guide UI is displayed. The location may indicate the location wherein the guide UI is displayed. The text size may indicate the size of the text included in the guide UI. The number of the words of the text may indicate the number of the words (or the number of the characters or the number of the lines) of the text included in the guide UI.

Referring to the embodiment 2010 in FIG. 20, in the electronic apparatus 100, the horizontal length of the display may be longer than the vertical length. The electronic apparatus 100 may display a guide UI11 based on the horizontal length and the vertical length of the display.

Referring to the embodiment 2020 in FIG. 20, in the electronic apparatus 100, the horizontal length of the display may be shorter than the vertical length. The electronic apparatus 100 may display a guide UI21 based on the horizontal length and the vertical length of the display.

The horizontal length of the display in the embodiment 2010 may be longer than the horizontal length of the display in the embodiment 2020. Also, the horizontal length of the guide UI11 in the embodiment 2010 may be longer than the horizontal length of the guide UI21 in the embodiment 2020.

FIG. 21 is a diagram for illustrating an operation of generating a guide UI according to an age according to an embodiment.

Referring to FIG. 21, the electronic apparatus 100 may display guide UIs 2111, 2121, 2132 based on an age included in the user information.

The electronic apparatus 100 may obtain an age included in the user information.

The content information may include an age restriction for viewing. The metadata included in the content information may include an age restriction for viewing. For example, a content that a person under the age of 18 cannot view may exist. The electronic apparatus 100 may compare the age restriction for viewing and the age included in the user information. The electronic apparatus 100 may generate a guide UI based on the comparison result.

If the user's age is higher than or equal to the age restriction for viewing of the content, the electronic apparatus 100 may display a guide UI including a representative text.

If the user's age is lower than the age restriction for viewing of the content, the electronic apparatus 100 may display a guide UI including guide information indicating that viewing is impossible.

The electronic apparatus 100 may identify a text size corresponding to the age. The electronic apparatus 100 may store a mapping table wherein text sizes for each age are mapped. The electronic apparatus 100 may identify a text size corresponding to the age based on the mapping table. The electronic apparatus 100 may display the guide UI based on the identified text size. As the age is higher, the guide UI may be displayed in a bigger text size.

Ages may be divided into predetermined groups. Ages under 60 may be divided into a first group. Ages 60 and over may be divided into a second group. The mapping table may include a first text size corresponding to the first group and a second text size corresponding to the second group. The second text size may be bigger than the first text size.

The electronic apparatus 100 may determine the number of words of the text based on the text size. The size of the area wherein the guide UI is displayed may have been set in advance. Accordingly, if the text size becomes bigger, the number of the words of the text displayed may decrease.

Referring to the embodiment 2110, it is assumed that the age restriction for viewing of the content is 18, and the age of the user is 12. The electronic apparatus 100 may display a guide UI 2111 including guide information indicating that the selected content cannot be viewed (viewing is prohibited for ages under 18) based on the age included in the user information. The guide information may include a graphic image indicating prohibition of viewing instead of a text.

Referring to the embodiment 2120, it is assumed that the age of the user belongs to the first group. The electronic apparatus 100 may display a guide UI 2121 based on the first text size corresponding to the first group.

Referring to the embodiment 2130, it is assumed that the age of the user belongs to the second group. The electronic apparatus 100 may display a guide UI 2131 based on the second text size corresponding to the second group.

In case the first group has higher ages than the second group, the second text size may be bigger than the first text size. The second text size may be a predetermined size. The second text size may be changed according to the user's setting.

As the text size determined in the embodiment 2130 is bigger than in the embodiment 2120, the number of the words of the text displayed in the embodiment 2130 may be fewer than in the embodiment 2120.

FIG. 22 is a diagram for illustrating an operation of generating a guide UI according to a language according to an embodiment.

Referring to FIG. 22, the electronic apparatus 100 may identify a language or a country included in the user information. The electronic apparatus 100 may display a guide UI based on the language or the country.

Referring to the embodiment 2210 in FIG. 22, the electronic apparatus 100 may display a guide UI 2211 based on the language (Korean) or the country (Korea) of the user.

Referring to the embodiment 2220 in FIG. 22, the electronic apparatus 100 may display a guide UI 2221 based on the language (English) or the country (U.S.) of the user.

Referring to the embodiment 2230 in FIG. 22, the electronic apparatus 100 may display a guide UI 2231 based on the language (Chinese) or the country (China) of the user.

FIG. 23 is a diagram for illustrating an operation of generating a guide UI based on an arrangement location of the electronic apparatus 100 according to an embodiment.

Referring to FIG. 23, the electronic apparatus 100 may generate a type of a guide UI based on the location wherein the electronic apparatus 100 is arranged. The type of the guide UI may include at least one of an audio type or an image type.

Referring to the embodiment 2310 in FIG. 23, the electronic apparatus 100 may be arranged in a driver's seat of a mobile vehicle. The electronic apparatus 100 may store information on the arrangement location. The electronic apparatus 100 may display a guide UI based on the information on the arrangement location. If the information on the arrangement location is the driver's seat, the electronic apparatus 100 may generate a guide UI 2311 of an audio type. The electronic apparatus 100 may output the guide UI 2311 of the audio type through the speaker 170 of the electronic apparatus 100.

Referring to the embodiment 2320 in FIG. 23, the electronic apparatus 100 may be arranged in a passenger seat, a seat in the second row, or a seat in the third row of a mobile vehicle. The electronic apparatus 100 may store information on the arrangement location. The electronic apparatus 100 may display a guide UI based on the information on the arrangement location. If the information on the arrangement location is the passenger seat, a seat in the second row, or a seat in the third row, the electronic apparatus 100 may generate a guide UI 2321 of a video type. The electronic apparatus 100 may output the guide UI 2321 of the video type through the display 140 of the electronic apparatus 100.

FIG. 24 is a diagram for illustrating an operation of overlapping a guide UI with a thumbnail text and displaying it according to an embodiment.

Referring to the embodiment 2410 in FIG. 24, the electronic apparatus 100 may display a thumbnail image of a content. The thumbnail image may include a thumbnail text 2411. The electronic apparatus 100 may display the thumbnail text 2411 in a specific area in the entire area of the thumbnail image.

Referring to the embodiment 2420 in FIG. 24, the electronic apparatus 100 may display a guide UI 2421 by overlapping it with the thumbnail text 2411 in the thumbnail image. The electronic apparatus 100 may identify an area wherein the thumbnail text 2411 is displayed. The electronic apparatus 100 may display the guide UI 2421 based on the identified area.

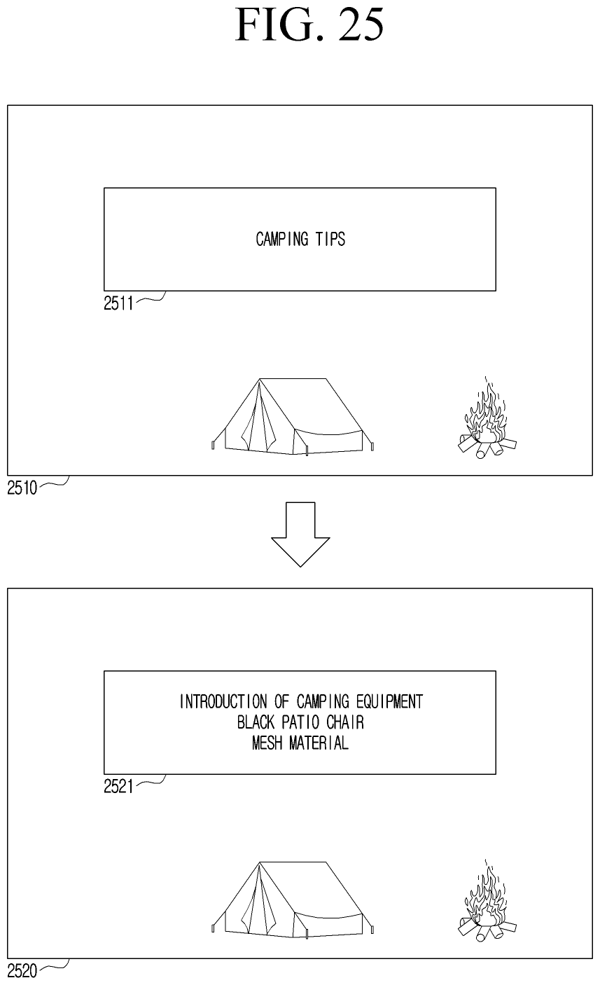

FIG. 25 is a diagram for illustrating an operation of generating a screen including a guide UI according to an embodiment.

Referring to the embodiment 2510 in FIG. 25, the electronic apparatus 100 may display a thumbnail image of a content.

Referring to the embodiment 2510 in FIG. 25, the electronic apparatus 100 may display a thumbnail image of a content. The thumbnail image may include a thumbnail text 2511. The electronic apparatus 100 may display the thumbnail text 2511 in a specific area in the entire area of the thumbnail image.

Referring to the embodiment 2520 in FIG. 25, the electronic apparatus 100 may remove the thumbnail text 2511 from the thumbnail image, and generate a new thumbnail image including a guide UI 2521 in the location wherein the removed thumbnail image 2511 was displayed. The electronic apparatus 100 may display the new thumbnail image.

The previous thumbnail image may be described as a first thumbnail image, and the newly generated thumbnail image may be described as a second thumbnail image.

The electronic apparatus 100 may use an image rendering function for generating a new thumbnail image. The image rendering function may include an operation of deleting an object displayed in a specific area and adding a new UI, and thereby generating one layer.

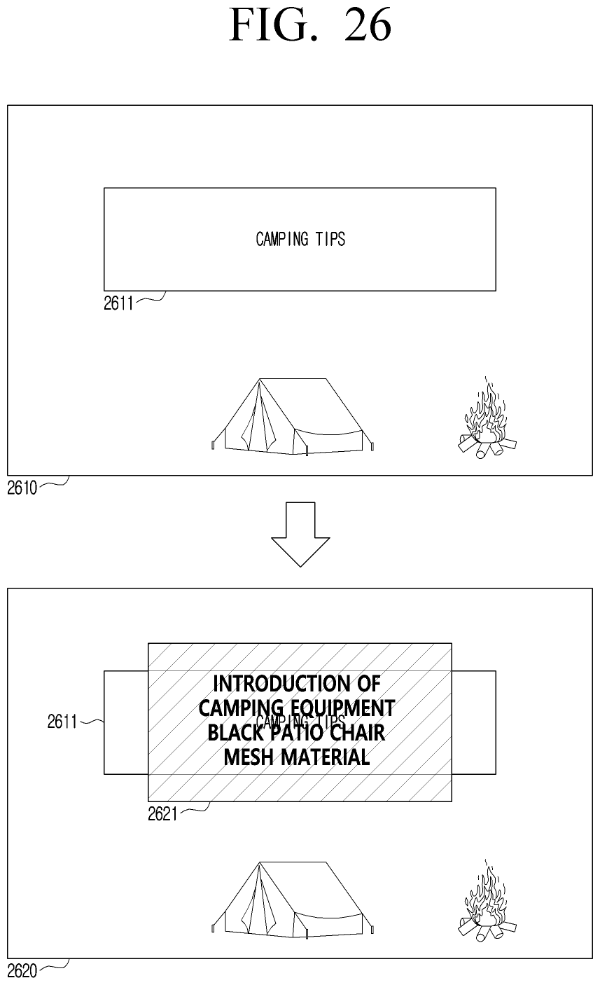

FIG. 26 is a diagram for illustrating an operation of applying transparency of a guide UI according to an embodiment.

Referring to the embodiment 2610 in FIG. 26, the electronic apparatus 100 may display a thumbnail image of a content. The thumbnail image may include a thumbnail text 2611. The electronic apparatus 100 may display the thumbnail text 2611 in a specific area in the entire area of the thumbnail image.

Referring to the embodiment 2620 in FIG. 26, the electronic apparatus 100 may display a guide UI 2621 by overlapping it with the thumbnail text 2611 in the thumbnail image. The electronic apparatus 100 may identify an area wherein the thumbnail text 2611 is displayed. The electronic apparatus 100 may display the guide UI 2621 based on the identified area.

The electronic apparatus 100 may display the guide UI 2621 based on predetermined transparency. The predetermined transparency may be changed according to the user's setting.

If the transparency exceeds 0%, the thumbnail text 2611 may be displayed to be overlapped with the guide UI 2621.

If the transparency is 0%, the thumbnail text 2611 covered by the guide UI 2621 may not be seen. An embodiment related to this will be described in FIG. 24.

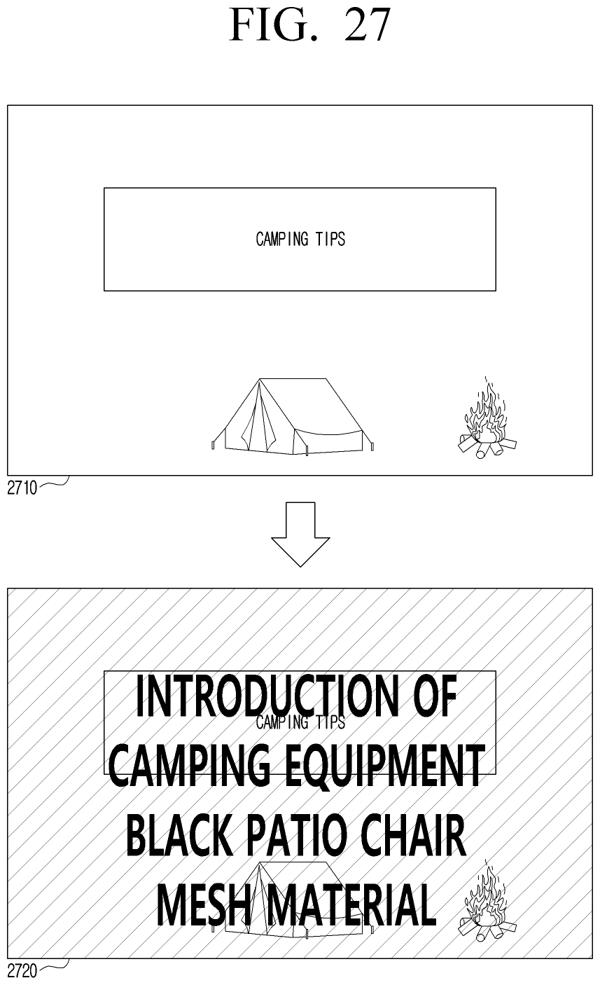

FIG. 27 is a diagram for illustrating an operation of displaying a guide UI to fit the size of an area wherein a content is displayed according to an embodiment.

Referring to the embodiment 2710 in FIG. 27, the electronic apparatus 100 may display a thumbnail image of a content. The thumbnail image may include a thumbnail text. The electronic apparatus 100 may display the thumbnail text in a specific area in the entire area of the thumbnail image.

Referring to the embodiment 2720 in FIG. 27, the electronic apparatus 100 may display a guide UI in the entire area wherein the thumbnail image is displayed. The guide UI may be displayed based on the predetermined transparency.

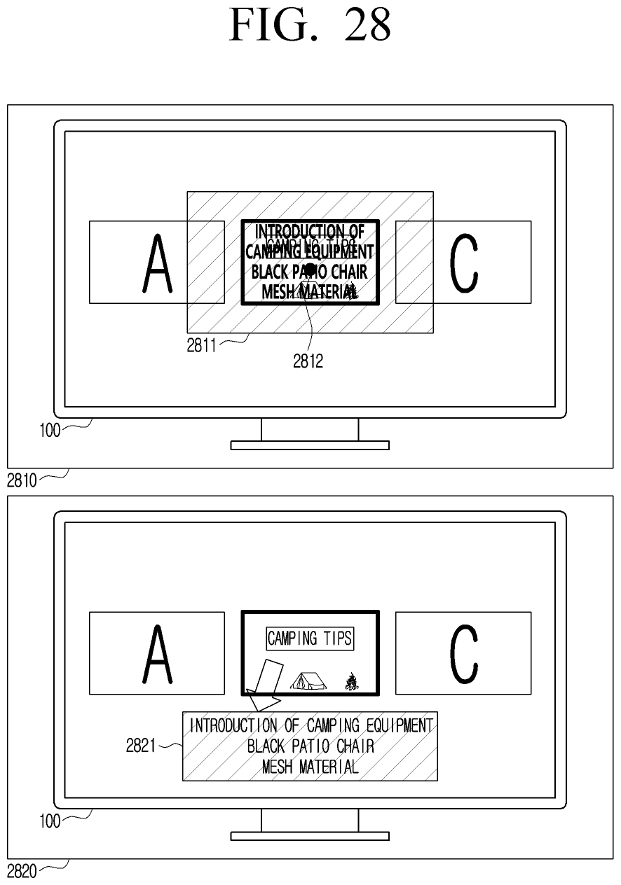

FIG. 28 is a diagram for illustrating an operation of displaying a guide UI in an area different from an area wherein a content is displayed according to an embodiment.

Referring to the embodiment 2810 in FIG. 28, the electronic apparatus 100 may display a guide UI 2811 based on an area wherein a thumbnail image of a selected content is displayed. The electronic apparatus 100 may identify a representative location 2812 of the area wherein the selected content is displayed. The electronic apparatus 100 may display the guide UI 2811 based on the representative location 2812. The representative location 2812 may not be actually displayed.

Referring to the embodiment 2820 in FIG. 28, the electronic apparatus 100 may identify an area wherein a thumbnail image of a selected content is displayed, and the remaining area wherein the thumbnail image is not displayed. The electronic apparatus 100 may display a guide UI 2821 in the remaining area wherein the thumbnail image is not displayed. The user can see the thumbnail image and the guide UI 2821 together.

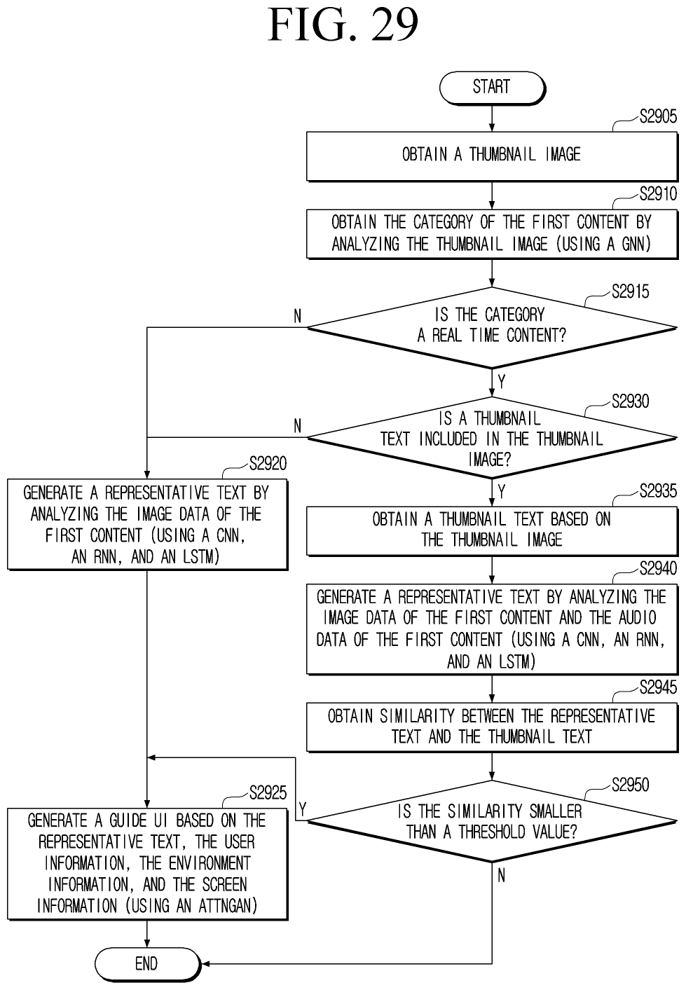

FIG. 29 is a flowchart illustrating an operation of generating a guide UI in consideration of a category of a content according to an embodiment.

Referring to FIG. 29, the electronic apparatus 100 may obtain a thumbnail image in the operation S2905. The electronic apparatus 100 may obtain the category of the first content by analyzing the thumbnail image in the operation S2910. As an example, the electronic apparatus 100 may analyze the thumbnail image by using a graph neural network (GNN).

The electronic apparatus 100 may identify whether the category is a real time content in the operation S2915. If the category is not a real time content in the operation S2915—N, the electronic apparatus 100 may generate a representative text by analyzing the image data (or the video data) of the first content in the operation S2920. As an example, the electronic apparatus 100 may analyze the image data by using at least one of a convolutional neural network (CNN), a recurrent neural network (RNN), or long short-term memory (LSTM).

The electronic apparatus 100 may generate a guide UI based on at least one of the representative text, the user information, the environment information, or the screen information in the operation S2925. As an example, the electronic apparatus 100 may generate a guide UI by using an attentional generative adversarial network (AttnGAN).

If the identified category is a real time content in the operation S2915—Y, the electronic apparatus 100 may identify whether a thumbnail text is included in the thumbnail image in the operation S2930.

In case a thumbnail text is not included in the thumbnail image in the operation S2930—N, the electronic apparatus 100 may perform the operations S2920 and S2925.

In case a thumbnail text is included in the thumbnail image in the operation S2930—Y, the electronic apparatus 100 may obtain the thumbnail text based on the thumbnail image in the operation S2935.

The electronic apparatus 100 may generate a representative text by analyzing the image data of the first content and the audio data of the first content in the operation S2940. As an example, the electronic apparatus 100 may analyze at least one of the image data or the audio data by using at least one of a convolutional neural network (CNN), a recurrent neural network (RNN), or long short-term memory (LSTM).

The electronic apparatus 100 may obtain similarity between the representative text and the thumbnail text in the operation S2945. The electronic apparatus 100 may identify whether the similarity is smaller than a threshold value in the operation S2950.

If the similarity is smaller than the threshold value in the operation S2950—Y, the electronic apparatus 100 may generate a guide UI based on at least one of the representative text, the user information, the environment information, or the screen information in the operation S2925.

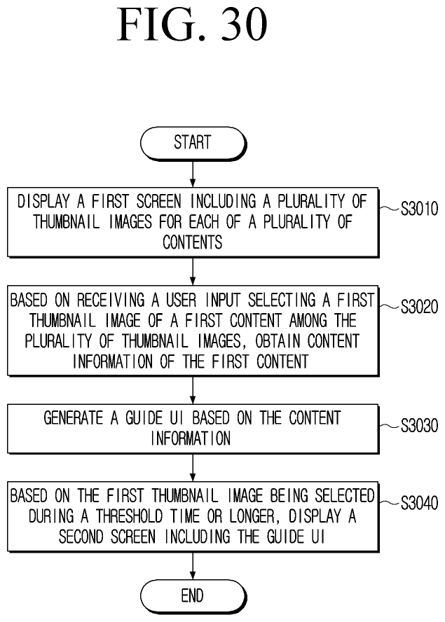

FIG. 30 is a flowchart illustrating a controlling method of the electronic apparatus 100 according to an embodiment.

Referring to FIG. 30, a controlling method of the electronic apparatus 100 may include the operations of displaying a first screen including a plurality of thumbnail images for each of a plurality of contents (e.g., operation S3010), and based on receiving a user input selecting a first thumbnail image of a first content among the plurality of thumbnail images, obtaining content information of the first content (e.g., operation S3020), generating a guide UI based on the content information (e.g., operation S3030), and based on the first thumbnail image being selected during a threshold time or longer, displaying a second screen including the guide UI (e.g., operation S3040).

The controlling method may include the operations of, based on receiving the user input selecting the first thumbnail image, displaying an activation UI in a location corresponding to the first thumbnail image, and in the operation S3040 of displaying the second screen, based on the location of the activation UI not being changed or being consistent on the display during the threshold time, the second screen including the guide UI may be displayed.

In the operation S3040 of displaying the second screen, based on a touch input for selecting the first thumbnail image being maintained during the threshold time or longer, the second screen including the guide UI may be displayed.

The content information may include at least one of image data, audio data, thumbnail data, or metadata of the first content, and the thumbnail data may include the first thumbnail image, and the metadata may include at least one of a title, a drafter, a provider, cast, story summary, a resolution, a codec, or an age restriction for viewing.

The controlling method may include the operations of identifying a thumbnail text based on the first thumbnail image, and obtaining a representative text of the first content based on the content information, and in the operation S3030 of generating the guide UI, based on identifying a predetermined event related to the thumbnail text, the guide UI may be generated.

The controlling method may include the operation of obtaining similarity between the thumbnail text and the representative text, and in the operation S3030 of generating the guide UI, based on the similarity being smaller than a threshold value, the guide UI may be generated.

In the operation S3030 of generating the guide UI, based on the thumbnail text including a predetermined text, the guide UI may be generated, and the predetermined text may include at least one of an interrogative expression, an exaggerated expression, or an advertising expression.

The controlling method may include the operation of obtaining user information including at least one of an account, a name, an age, a sex, a language, a country, health, or a preferred category, and in the operation S3030 of generating the guide UI, the guide UI may be generated based on the content information and the user information.

The controlling method may include the operation of obtaining environment information including at least one of a location, a date, or weather, and in the operation S3030 of generating the guide UI, the guide UI may be generated based on the content information and the environment information.

The controlling method may include the operation of obtaining screen information including at least one of a resolution of the display or a resolution of an area wherein the first thumbnail image is displayed, and in the operation S3030 of generating the guide UI, the guide UI may be generated based on the content information and the screen information.

Meanwhile, methods according to the aforementioned various embodiments of the disclosure can be implemented in forms of applications that can be installed on a conventional electronic apparatus.

Also, the methods according to the aforementioned various embodiments of the disclosure may be implemented just with software upgrade, or hardware upgrade for a conventional electronic apparatus.

In addition, it is also possible that the aforementioned various embodiments of the disclosure are performed through an embedded server provided on an electronic apparatus, or an external server of at least one of an electronic apparatus or a display apparatus.

Meanwhile, according to an embodiment of the disclosure, the aforementioned various embodiments may be implemented as software including instructions stored in machine-readable storage media, which can be read by machines (e.g.: computers). The machines refer to apparatuses that call instructions stored in a storage medium, and can operate according to the called instructions, and the apparatuses may include an electronic apparatus according to the aforementioned embodiments. In case an instruction is executed by a processor, the processor may perform a function corresponding to the instruction by itself, or by using other components under its control. An instruction may include a code that is generated or executed by a compiler or an interpreter. A storage medium that is readable by machines may be provided in the form of a non-transitory storage medium. Here, the term ‘non-transitory’ only means that a storage medium does not include signals, and is tangible, and the term does not distinguish a case wherein data is stored in the storage medium semi-permanently and a case wherein data is stored temporarily.

Also, according to an embodiment of the disclosure, the methods according to the aforementioned various embodiments may be provided while being included in a computer program product. A computer program product refers to a product, and it can be traded between a seller and a buyer. A computer program product can be distributed in the form of a storage medium that is readable by machines (e.g.: compact disc read only memory (CD-ROM)), or distributed on-line through an application store. In the case of on-line distribution, at least a portion of a computer program product may be stored in a storage medium such as the server of the manufacturer, the server of the application store, and the memory of the relay server at least temporarily, or may be generated temporarily.

In addition, each of the components (e.g.: a module or a program) according to the aforementioned various embodiments may consist of a singular object or a plurality of objects. Also, among the aforementioned corresponding sub components, some sub components may be omitted, or other sub components may be further included in the various embodiments. Alternatively or additionally, some components (e.g.: a module or a program) may be integrated as an object, and perform functions that were performed by each of the components before integration identically or in a similar manner. Further, operations performed by a module, a program, or other components according to the various embodiments may be executed sequentially, in parallel, repetitively, or heuristically. Or, at least some of the operations may be executed in a different order or omitted, or other operations may be added.

Also, while preferred embodiments of the disclosure have been shown and described, the disclosure is not limited to the aforementioned specific embodiments, and it is apparent that various modifications may be made by those having ordinary skill in the technical field to which the disclosure belongs, without departing from the gist of the disclosure as claimed by the appended claims. Further, it is intended that such modifications are not to be interpreted independently from the technical idea or prospect of the disclosure.

What is claimed is:

1. An electronic apparatus comprising:
memory storing instructions;
a display; and
at least one processor including processing circuitry,
wherein the instructions, when executed by the at least one processor individually or collectively, cause the electronic apparatus to:
display, on the display, a first screen comprising a plurality of thumbnail images for each of a plurality of contents,
based on receiving a user input selecting a first thumbnail image of a first content among the plurality of thumbnail images, obtain content information of the first content,
generate a guide user interface (UI) based on the content information, and
based on the user input being received for at least a threshold time, display a second screen comprising the guide UI.

2. The electronic apparatus of claim 1,
wherein the instructions, when executed by the at least one processor individually or collectively, further cause the electronic apparatus to:
based on receiving the user input, display an activation UI at a location corresponding to the first thumbnail image, and
based on the location of the activation UI being consistent for at least the threshold time, display the second screen comprising the guide UI.

3. The electronic apparatus of claim 1,
wherein the instructions, when executed by the at least one processor individually or collectively, further cause the electronic apparatus to:
based on a touch input for selecting the first thumbnail image being maintained for at least the threshold time, display the second screen comprising the guide UI.

4. The electronic apparatus of claim 1,
wherein the content information comprises:
at least one of image data, audio data, thumbnail data, or metadata of the first content, and
wherein the thumbnail data comprises:
the first thumbnail image, and
wherein the metadata comprises:
at least one of a title, a drafter, a provider, cast, story summary, a resolution, a codec, or an age restriction for viewing.

5. The electronic apparatus of claim 1,
wherein the instructions, when executed by the at least one processor individually or collectively, further cause the electronic apparatus to:
identify a thumbnail text based on the first thumbnail image,
obtain a representative text of the first content based on the content information, and
based on identifying a predetermined event related to the thumbnail text, generate the guide UI.

6. The electronic apparatus of claim 5,
wherein the instructions, when executed by the at least one processor individually or collectively, further cause the electronic apparatus to:
generate the guide UI based on a similarity between the thumbnail text and the representative text.

7. The electronic apparatus of claim 5,
wherein the instructions, when executed by the at least one processor individually or collectively, further cause the electronic apparatus to:
based on the thumbnail text including a predetermined text, generate the guide UI,
wherein the predetermined text comprises:
at least one of an interrogative expression, an exaggerated expression, or an advertising expression.

8. The electronic apparatus of claim 1,
wherein the instructions, when executed by the at least one processor individually or collectively, further cause the electronic apparatus to:
obtain user information including at least one of an account, a name, an age, a sex, a language, a country, health, or a preferred category, and
generate the guide UI based on the content information and the user information.

9. The electronic apparatus of claim 1,
wherein the instructions, when executed by the at least one processor individually or collectively, further cause the electronic apparatus to:
obtain environment information including at least one of a location, a date, or weather, and
generate the guide UI based on the content information and the environment information.

10. The electronic apparatus of claim 1,
wherein the instructions, when executed by the at least one processor individually or collectively, further cause the electronic apparatus to:
obtain screen information including at least one of a resolution of the display or a resolution of an area where the first thumbnail image is displayed, and
generate the guide UI based on the content information and the screen information.

11. A controlling method of an electronic apparatus, the controlling method being performed by one or more processors, and the controlling method comprising:
displaying a first screen comprising a plurality of thumbnail images for each of a plurality of contents;
based on receiving a user input selecting a first thumbnail image of a first content among the plurality of thumbnail images, obtaining content information of the first content;
generating a guide user interface (UI) based on the content information; and
based on the user input being received for at least a threshold time, displaying a second screen comprising the guide UI.

12. The controlling method of claim 11,
wherein the controlling method further comprises:
based on receiving the user input, displaying an activation UI at a location corresponding to the first thumbnail image, and
wherein the displaying the second screen comprises:
based on the location of the activation UI being consistent for at least the threshold time, displaying the second screen comprising the guide UI.

13. The controlling method of claim 11, wherein the displaying the second screen comprises:
based on a touch input for selecting the first thumbnail image being maintained for at least the threshold time, displaying the second screen comprising the guide UI.

14. The controlling method of claim 11,
wherein the content information comprises:
at least one of image data, audio data, thumbnail data, or metadata of the first content, and
wherein the thumbnail data comprises:
the first thumbnail image, and
wherein the metadata comprises:
at least one of a title, a drafter, a provider, cast, story summary, a resolution, a codec, or an age restriction for viewing.

15. The controlling method of claim 11,
wherein the controlling method further comprises:
identifying a thumbnail text based on the first thumbnail image; and
obtaining a representative text of the first content based on the content information, and
wherein the generating the guide UI comprises:
based on identifying a predetermined event related to the thumbnail text, generating the guide UI.

16. The controlling method of claim 15, wherein the generating the guide UI further comprises:
generating the guide UI based on a similarity between the thumbnail text and the representative text.

17. A non-transitory computer-readable medium storing instructions, the instructions comprising one or more instructions that, when executed by one or more processors individually or collectively, cause the one or more processors to:
display a first screen comprising a plurality of thumbnail images for each of a plurality of contents,
based on receiving a user input selecting a first thumbnail image of a first content among the plurality of thumbnail images, obtain content information of the first content,
generate a guide user interface (UI) based on the content information, and
based on the user input being received for at least a threshold time, display a second screen comprising the guide UI.

18. The non-transitory computer-readable medium of claim 17, wherein the instructions, when executed by one or more processors individually or collectively, further cause the one or more processors to:
based on receiving the user input, display an activation UI at a location corresponding to the first thumbnail image, and
based on the location of the activation UI being consistent for at least the threshold time, display the second screen comprising the guide UI.

19. The non-transitory computer-readable medium of claim 17, wherein the instructions, when executed by one or more processors individually or collectively, further cause the one or more processors to:
based on a touch input for selecting the first thumbnail image being maintained for at least the threshold time, display the second screen comprising the guide UI.

20. The non-transitory computer-readable medium of claim 17, wherein the instructions, when executed by one or more processors individually or collectively, further cause the one or more processors to:
identify a thumbnail text based on the first thumbnail image,
obtain a representative text of the first content based on the content information, and
based on a similarity between the thumbnail text and the representative text, generate the guide UI.
